(19) United States
(12) Patent Application Publication
(10) Pub. No.: US 2026/0369073 A1
(43) Pub. Date: Nov. 19, 2026

(54) First Node, Second Node and Methods Performed Thereby, for Handling Object Identification

(71) Applicant: Telefonaktiebolaget LM Ericsson (publ), Stockholm (SE)

(72) Inventors: Martin Ek, Lund (SE); Anastasia Grebenyuk, Lund (SE)

(21) Appl. No.: 19/514,970

(22) PCT Filed: Aug. 28, 2023
(86) PCT No.: PCT/SE2023/050858

§ 371 Date: Feb. 27, 2026

(51) Int. Cl. G06V 20/58; G06N 3/0464; G06N 3/08; G06V 10/60; G06V 20/70

(52) U.S. Cl. CPC G06V 20/58; G06N 3/0464; G06N 3/08; G06V 10/60; G06V 20/70; G06V 2201/07

(57) ABSTRACT

A computer-implemented method performed by a first node (111). The method is for handling object identification. The first node (111) operates in a communications system (100). The first node (111) determines (307), using a first predictive model (122) to identify one or more objects in digital images, one or more first digital image first objects in a first digital image. The determining (307) is based on first information indicating one or more first properties of an illumination in the first digital image. The determining (307) is also based on second information indicating one or more second properties of a respective reflectance of the first digital image. The first node (111) then initiates (308) outputting an indication of the determined one or more first objects.

### TECHNICAL FIELD

The present disclosure relates generally to a first node and methods performed thereby for handling object identification. The present disclosure further relates generally to a second node and methods performed thereby, for handling object identification. The present disclosure also relates generally to computer programs and computer-readable storage mediums, having stored thereon the computer programs to carry out these methods.

### BACKGROUND

Computer systems in a communications network or communications system may comprise one or more nodes. A node may comprise one or more processors which, together with computer program code may perform different functions and actions, a memory, a receiving port, and a sending port. A node may be, for example, a server. Nodes may perform their functions entirely on the cloud.

Computer systems may be comprised in a telecommunications network. The telecommunications network may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR), as well as a Fifth Generation (5G) Packet Core Network, which may be referred to as 5G Core Network (5GC). The advantages of 5G NR may include higher bandwidth, more resources, low latency and network slicing. 5G may provide services to various applications, such as enhanced Mobile Broad Band (eMBB), machine to Machine type communication (mMTC), Ultra Reliable Low Latency Communication (URLLC), etc.

5G may be understood to bring in sizeable flexibility with technological advancements along with innovations of cloud and AI. This may be understood to bring a whole new set of opportunities in the enterprise segment.

For many enterprises, mobile cellular technology has already proven to bring great value to their digitalization process, which may include numerous use cases, such as autonomous robotics, enhanced video services, connected vehicles, remote operations, hazard, and maintenance sensors etc. This may be understood to not only enhance productivity in connected factories, but also make workplaces safer.

In the course of operations of the telecommunications network, data may be collected via the telecommunications network, which may enable to monitor and manage different functions.

The advent of for example, the Internet of Things (IoT) has exponentially increased the amount of data to be monitored. The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events. Within this context, machine learning models may be used to analyze the data collected, and enable an improved management of different types of operations via the telecommunications network.

### Machine Learning

Machine learning (ML) may be understood as the study of computer algorithms that may improve automatically through experience. It is seen as a part of Artificial Intelligence (AI). ML algorithms may build a model based on sample data, known as “training data”, in order to make predictions or decisions without being explicitly programmed to do so. ML algorithms may be used in a wide variety of applications, such as email filtering and computer vision, where it may be difficult or unfeasible to develop conventional algorithms to perform the needed tasks.

There may be basically 3 types of ML Algorithms: Supervised Learning, Unsupervised Learning, and Reinforcement Learning (RL).

Supervised Learning algorithms may comprise a target/outcome variable, or dependent variable, which may have to be predicted from a given set of predictors, that is, independent variables. Using this set of variables, a function may be generated that may map inputs to desired outputs. The training process may continue until the model may achieve a desired level of accuracy on the training data. Once an ML model may have been trained, an inference process may begin, whereby new data may be run through the ML model to calculate an output. Examples of Supervised Learning may be Regression, Decision Tree, Random Forest, KNN, Logistic Regression etc.

In Unsupervised Learning algorithms, there may be no target or outcome variable to predict/estimate. It may be used for clustering a population into different groups, which may be widely used for segmenting customers in different groups for specific intervention. Examples of Unsupervised Learning may be K-means, mean-shift clustering, Density-Based Spatial Clustering of Applications with Noise (DBSCAN), Expectation-Maximization (EM) Clustering using Gaussian Mixture Models (GMM), Agglomerative Hierarchical Clustering, etc.

Cluster analysis or clustering may be understood as an ML technique which may comprise grouping a set of objects in such a way that objects in the same group, which may be called a cluster, may be understood to be more similar, in some sense, to each other than to those in other groups, that is, other clusters. It may be understood as a main task of exploratory data mining, and a common technique for statistical data analysis, used in many fields, including pattern recognition, image analysis, information retrieval, bioinformatics, data compression, computer graphics and ML.

Using an RL algorithm, a machine may be trained to make specific decisions. It may be understood to work as follows: the machine may be exposed to an environment where it may train itself continually using trial and error. This machine may learn from past experience and may try to capture the best possible knowledge to make accurate decisions. An example of RL may be a Markov Decision Process (MDP). The training using RL may comprise generating an ML model. To train such an ML model, an agent, given a state of the environment, may take an action in this environment and receive a reward. The action may result in a new state of the environment. This process may be repeated in a loop. Over time, the agent may learn to take actions that may result in larger immediate and future rewards, meaning that it may be understood to be in the best interest of the agent not to take the action that may only lead to the highest reward in the next state, but the action that may cumulatively lead to the highest reward in the next state and in a future number of states.

The agent may comprise a neural network which may input the state and may produce an action. There may be several ML algorithms that may be used for training the network of the agent, e.g., policy-learning based, such as actor-critic approaches, or value-based learning, such as deep-q networks.

Object detection, a key aspect of computer vision, has rapidly progressed in recent years, particularly with the advent of deep learning techniques. Traditional object detection models may primarily rely on Red Green Blue (RGB) images. An RGB image may be understood as an image where each picture element, e.g., pixel, may be described by a light intensity for each of the three primary colors: red, green and blue. These object detection methods relying on RGB images may analyze patterns within the visible light spectrum reflected by objects to identify and classify them. However, these RGB-based detection methods face significant challenges due to variable lighting conditions. The appearance of an object in an RGB image may be greatly influenced by the characteristics of the ambient light, such as its intensity, direction, and color. For instance, an object illuminated under bright sunlight may have totally different RGB characteristics compared to when it is under artificial light or in the shadows. Such variations in lighting conditions may detrimentally affect the performance and reliability of object detection models, leading to imprecise identifications and classifications.

### SUMMARY

As part of the development of embodiments herein, one or more problems with the existing technology will first be identified and discussed.

A significant problem with object detection models based on RGB images is that the method depends on object reaction to light. Since the illumination often varies, the method becomes sensitive to this issue.

To address these limitations, one of the approaches that may be taken may be to consider intrinsic characteristics of an object, its reflectance properties. The reflectance properties of an object, which may relate to how the object may reflect light in various spectra, may be understood to remain consistent regardless of the illumination. This may be understood to mean that by incorporating these properties into the ML models of object detection, the influence of variable lighting conditions may be mitigated.

Utilizing the reflectance of an object may not only improve the accuracy of object detection and semantic labelling, but also provide more granular details, such as the state of an object. The state of an object may be understood as a description of a general condition of the object. For example, the state of an object may be e.g., wet, dry, dusty, clean, healthy, sick etc.

Semantic segmentation may be understood as a process where each pixel in an image may be classified into a specific category or class, such that pixels with the same semantic meaning may share the same label. One challenge in semantic segmentation is handling specific illumination cases, such as highly reflective surfaces that result in excessive brightness.

Most of the existing work relies on additional sensors to analyze to interpret and classify the objects and its materials by analyzing their reflectance data. Existing approaches, such as those described in [1], often rely on the use of additional sensors to enhance the accuracy of the semantic masks.

While object label prediction models may achieve high accuracy, they often lack the ability to provide detailed descriptions of surface features, or the state of objects based solely on RGB images. Addressing the state of objects and their reflectance may often require the use of additional sensors, such as Lidar or polarization sensing systems [2]. In this context, different hardware modalities, where each may represent a different type of hardware designed to sense or capture specific types of data, may be combined with RGB images, including polarization [1], as well as data from sensors such as radar, lidar, or ultrasonic sensors, specifically utilizing the signal intensity information from these sensors [2].

Only few existing approaches address the reflectance properties of the objects based on the RGB images only, where the reflectance may be an input to the models and not a result of calculations. Some studies [3, 4] have addressed the question of how to improve machine learning performance by considering reflectance based on RGB images alone. However, these approaches have certain limitations in that they may be limited in the specific domain and may not work in a ubiquitous way.

In one or the approaches [3], the authors deal with image sequences, such as video, and propose use of a support vector machine (SVM) to learn reflection feature points. Image sequences may be treated as two layers superimposed over each other-the non-reflection scene source layer and the reflection layer. The approach does not work for non-sequential images, and they do not use illumination properties.

Another approach [4] aims to improve the performance of industrial bin-picking tasks by reducing the effects of specular reflections. This work addresses a specific industrial problem using specific synthetic data for training. It also uses camera information. The approach does not use illumination information for training. The state of the object is not provided as an output. This approach does not work for inter-reflections and the real-world outdoor scene, which may be the situation for other similar studies.

In all, existing methods of object detection may have high cost due to costly hardware requirements, which may also increase the cumbersomeness of the calculations, may not be ubiquitously applied, and may provide an incomplete picture of the detected objects. Furthermore, adding physical sensors does not fit well for head mounted devices, where weight and industrial design may be understood to be highly prioritized. It is therefore an object of embodiments herein to improve the handling of object identification.

Embodiments herein may address the problems of the existing methods described by introducing the reflectance properties of the object in both the learning and inference steps of a machine learning procedure, without adding dedicated measuring hardware. The reflectance properties of an object may be understood to be intrinsic and to not change due to illumination. This may then provide the opportunity for more accurate predictions of labels and semantic, as well as open for a more detailed labelling by introducing the state of an object.

According to a first aspect of embodiments herein, the object is achieved by a computer-implemented method, performed by a first node. The method is for handling object identification. The first node operates in a computer system. The first node determines, using a first predictive model to identify one or more objects in digital images, one or more first objects in a first digital image. The determining is based on first information. The first information indicates one or more first properties of an illumination in the first digital image. The determining is also based on second information. The second information indicates one or more second properties of a respective reflectance of the first digital image. The first node then initiates outputting an indication of the determined one or more first objects.

According to a second aspect of embodiments herein, the object is achieved by a computer-implemented method, performed by the second node. The method is for handling object identification. The second node operates in the computer system. The second node determines, using machine learning, the first predictive model to identify one or more objects in digital images. The determining of the first predictive model comprises training the first predictive model using a plurality of sets of information. Each of the sets of information comprises a respective second digital image. Each of the sets of information also comprises respective annotations of the respective second digital image. The respective annotations indicate a respective identification of one or more respective second objects in the respective second digital image. The respective annotations also indicate respective third information indicating a respective state of the identified one or more respective second objects. Each of the sets of information further comprises respective first information indicating one or more respective first properties of an illumination in the respective second digital image. Each of the sets of information additionally comprises respective second information indicating one or more respective second properties of a respective reflectance of the respective second digital image. The second node then outputs a first indication of the determined first predictive model.

According to a third aspect of embodiments herein, the object is achieved by the first node. The first node may be understood to be for handling object identification. The first node is configured to operate in the computer system. The first node is further configured to determine, using the first predictive model to identify one or more objects in digital images, the one or more first objects in the first digital image. The determining is configured to be based on: i) the first information configured to indicate the one or more first properties of the illumination in the first digital image, and ii) the second information configured to indicate the one or more second properties of the respective reflectance of the first digital image. The first node is also configured to initiate outputting the indication of the one or more first objects configured to be determined.

According to a fourth aspect of embodiments herein, the object is achieved by the second node. The second node may be understood to be for handling object identification. The second node is configured to operate in the computer system. The second node is configured to determine, using machine learning, the first predictive model to identify one or more objects in digital images. The determining of the first predictive model is configured to comprise training the first predictive model using the plurality of sets of information. Each of the sets of information is configured to comprise the respective second digital image. Each of the sets of information is also configured to comprise the respective annotations of the respective second digital image. The respective annotations are configured to indicate the respective identification of one or more respective second objects in the respective second digital image. The respective annotations are further configured to indicate the respective third information configured to indicate the respective state of the one or more respective second objects configured to be identified. Each of the sets of information is further configured to comprise the respective first information configured to indicate the one or more respective first properties of the illumination in the respective second digital image. Each of the sets of information is additionally configured to comprise the respective second information configured to indicate the one or more respective second properties of the respective reflectance of the respective second digital image. The second node is further configured to output the first indication of the first predictive model configured to be determined.

According to a fifth aspect of embodiments herein, the object is achieved by a computer program, comprising instructions which, when executed on at least one processing circuitry, cause the at least one processing circuitry to carry out the method performed by the first node.

According to a sixth aspect of embodiments herein, the object is achieved by a computer-readable storage medium, having stored thereon the computer program, comprising instructions which, when executed on at least one processing circuitry, cause the at least one processing circuitry to carry out the method performed by the first node.

According to a seventh aspect of embodiments herein, the object is achieved by a computer program, comprising instructions which, when executed on at least one processing circuitry, cause the at least one processing circuitry to carry out the method performed by the second node.

According to an eighth aspect of embodiments herein, the object is achieved by a computer-readable storage medium, having stored thereon the computer program, comprising instructions which, when executed on at least one processing circuitry, cause the at least one processing circuitry to carry out the method performed by the second node.

As stated earlier, the reflectance properties of an object may be understood to be intrinsic and to not change due to illumination. This may then provide the opportunity for more accurate predictions of labels and semantic, as well as open for a more detailed labelling by introducing the state of an object.

By determining the first predictive model to identify the one or more objects in the digital images, the second node may be enabled to provide the trained model to the first node, which may then use the first predictive model to identify one or more objects in digital images. This may be understood to be performed with higher efficiency and higher accuracy than existing approaches, and provide further information, e.g., the state of the identified objects, than existing approaches. By using as input the respective annotations, the respective first information and the respective second information, the second node may be enabled to achieve more precise object detection, improved semantic segmentation, and provide better understanding of the state of the objects.

Advantageously, introducing knowledge of object reflectance properties in an image-based object detection system may allow for a more exact way of identifying complete and segmented parts of objects from a digital image, e.g., an RGB image, without adding requirements of additional hardware.

By outputting the first indication, the second node may enable to provide one or more objects identified in digital images. In some examples, the first indication may be one or more of a label of any object identified in a respective second image, a state of the object and a segmentation mask.

By outputting the first indication, the second node may enable the first node to then use the first predictive model to identify the one or more first objects in the first digital image.

By using the first predictive model, the first node may be enabled to identify the one or more first objects in the first digital image with higher efficiency and higher accuracy than existing approaches, and provide further information, e.g., the state of the identified objects, than existing approaches. By using as input the first information and the second information, the first node may be enabled to achieve more precise object detection, improved semantic segmentation, and provide better understanding of the state of the one or more first objects. The determined first predictive model may enable the first node, using the first digital image, light source input and a “reflectance image” as input to the first predictive model, to obtain the indication, such as, e.g., object labels, object state/types and semantic masks. Higher-level knowledge of the state of an object may be achieved using reflective and surface property knowledge about the object, e.g., a low reflectance car, may be a dirty car or a glossy face may be a sweaty face.

By initiating outputting the indication, referred to herein as a second indication, the first node may be enabled to share the outcome of the determination with another node or user, enabling to achieve the advantages already explained above.

### BRIEF DESCRIPTION OF THE DRAWINGS

Examples of embodiments herein are described in more detail with reference to the accompanying drawings, according to the following description.

FIG. 1 is a schematic diagram illustrating two non-limiting examples, in panels a) and b), of a computer system, according to embodiments herein.

FIG. 2 is a flowchart depicting a method in a second node, according to embodiments herein.

FIG. 3 is a flowchart depicting a method in a first node, according to embodiments herein.

FIG. 4 is a schematic diagram depicting a further non-limiting example of the method performed by the second node, according to embodiments herein.

FIG. 5 is a schematic diagram depicting another non-limiting example of the method performed by the first node, according to embodiments herein.

FIG. 6 is a schematic diagram depicting particular aspects of a non-limiting example of the method performed by any of the first node and the second node, according to embodiments herein.

FIG. 7 is a schematic diagram depicting particular aspects of another non-limiting example of the method performed by any of the first node and the second node, according to embodiments herein.

FIG. 8 is a schematic diagram depicting particular aspects of a further non-limiting example of the method performed by any of the first node and the second node, according to embodiments herein.

FIG. 9 is a schematic diagram depicting particular aspects of an additional non-limiting example of the method performed by any of the first node and the second node, according to embodiments herein.

FIG. 10 is a schematic diagram depicting particular aspects of an additional non-limiting example of the method performed by any of the first node and the second node, according to embodiments herein.

FIG. 11 is a schematic block diagram illustrating an embodiment of a first node, according to embodiments herein.

FIG. 12 is a schematic block diagram illustrating an embodiment of a second node, according to embodiments herein.

### DETAILED DESCRIPTION

Certain aspects of the present disclosure and their embodiments address the challenges identified in the Background and Summary sections with the existing methods and provide solutions to the challenges discussed.

Embodiments herein may be understood to relate to object detection and segmentation based on reflective and illumination properties.

Embodiments herein may be understood to enable to overcome the challenges mentioned in the Summary section by combining digital images, e.g., RGB images, reflectance properties, and light source information to build an advanced machine learning (ML) model of object detection. For this, the annotation on the input images, e.g., RGB images, may be extended to include the state of an object and surface. A “reflectance image” may then be calculated based on all the inputs.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

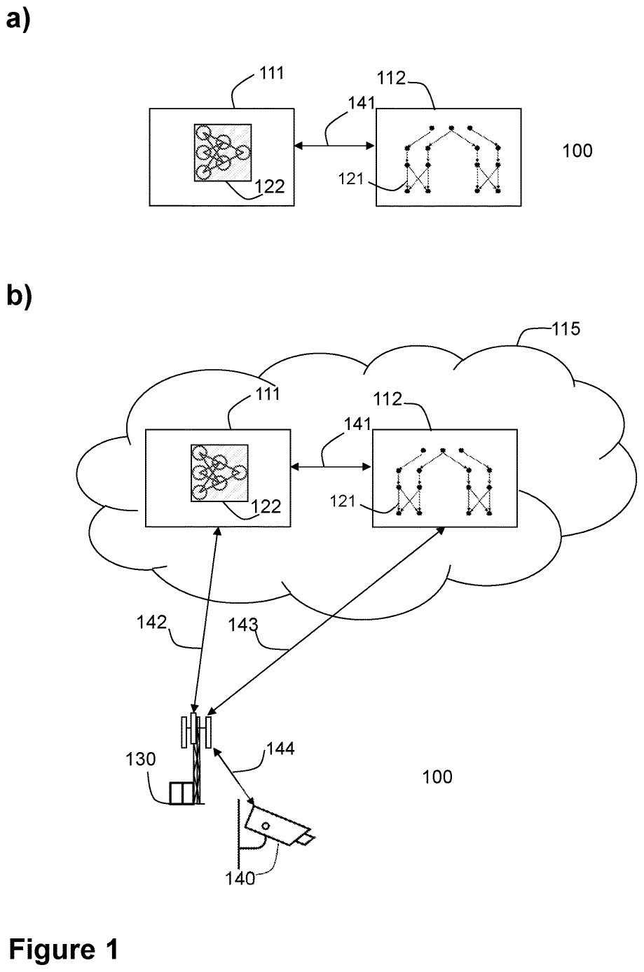

FIG. 1 depicts two non-limiting examples, in panels “a” and “b”, respectively, of a computer system 100, in which embodiments herein may be implemented. In some example implementations, such as that depicted in the non-limiting examples of FIG. 1, the computer system 100 may be a computer network. In other example implementations, such as that depicted in panel b) of FIG. 1, the computer system 100 may be implemented in a telecommunications system, sometimes also referred to as a cellular radio system, cellular network or wireless communications system. In some examples, the telecommunications system may comprise network nodes which may serve receiving nodes, such as wireless devices, with serving beams.

In some examples, the telecommunications system may be, for example, a communications network, such as 5G system, or Next Gen network. The telecommunications system may also, or alternatively, support other technologies, such as LTE, e.g., LTE Frequency Division Duplex (FDD), LTE Time Division Duplex (TDD), LTE Half-Duplex Frequency Division Duplex (HD-FDD), LTE operating in an unlicensed band. The telecommunications system may, additionally or alternatively, support other technologies, such as Wideband Code Division Multiple Access (WCDMA), Universal Terrestrial Radio Access (UTRA) TDD, Global System for Mobile communication (GSM)/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), Internet of Things (IoT), Machine Type Communication (MTC), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

The computer system 100 comprises nodes, whereof a first node 111 and a second node 112 are depicted in FIG. 1. In some examples, which are not depicted in FIG. 1, the first node 111 and the same node 112 may be co-located or be the same node. The computer system 100 may comprise additional nodes.

Any of the first node 111 and the second node 112 may be understood, respectively, as a first computer system or server, and a second computer system or server. Any of the first node 111 and the second node 112 may be implemented as a standalone server in e.g., a host computer in the cloud 115, as depicted in the non-limiting example of FIG. 1b). In other examples, any of the first node 111 and the second node 112 may be a distributed node or distributed server, such as a virtual node in the cloud 115, and may perform some of its respective functions locally, e.g., by a client manager, and some of its functions in the cloud 115, by e.g., a server manager. In other examples, any of the first node 111 and the second node 112 may perform its functions entirely on the cloud 115, or partially, in collaboration or collocated with a radio network node. Yet in other examples, any of the first node 111 and the second node 112 may also be implemented as processing resources in a server farm. In yet other examples, any of the first node 111 and the second node 112 may be comprised in a device, such as the device 140 described below, or on the edge. Any of the first node 111 and the second node 112 may be under the ownership or control of a service provider or may be operated by the service provider, or on behalf of the service provider.

Any of the first node 111, and the second node 112 may have a capability to perform machine-implemented learning procedures, which may be also referred to as “machine learning” (ML).

Particularly, the second node 112 may have a capability to manage an artificial neural network 121. The artificial neural network 121 may be understood as a machine learning framework, which may comprise a collection of connected nodes, where in each node or perceptron, there may be an elementary decision unit. Each such node may have one or more inputs and an output. The input to a node may be from the output of another node or from a data source. Each of the nodes and connections may have certain weights or parameters associated with it. In order to solve a decision task, the weights may be learnt or optimized over a data set which may be representative of the decision task. The most commonly used node may have each input separately weighted, and the sum may be passed through a non-linear function which may be known as an activation function. The nature of the connections and the node may determine the type of the neural network, for example a feedforward network, recurrent neural network etc. That the second node 112 may have the capability to manage the artificial neural network 121 may be understood herein as having the capability to store the training data set and the models that may result from the machine learning, to train a new model, herein referred to as a first predictive model 122, and once the model may have been trained, to use this model for prediction. In some embodiments, such as those depicted in in FIG. 1, the system that may be used for training the model and the one used for prediction may be different. That is, the first node 111 may be different from the second node 112. The first node 111 may be understood as a node having a capability to use the first predictive mode 122, once the model may have already been trained.

The second node 112 used for training the model may require more computational resources than the first node 111 that may use the built/trained model to make predictions. Therefore, second node 112 may, for example, support running python/Java with Tensorflow or Pytorch, Theano etc. The second node 112 may also have GPU capabilities.

In some embodiments, any of the first node 111 and the second node 112 may be a core network node, such as, e.g., a network data analytics function (NWDAF), a Service management and orchestration (SMO) node, a positioning node, a coordinating node, a Self-Optimizing/Organizing Network (SON) node, a Minimization of Drive Test (MDT) node, etc. In 5G, for example, any of the first node 111 and the second node 112 may be located in the Operations Support Systems (OSS).

In other examples not depicted in FIG. 1, any of the first node 111 and the second node 112 may be a radio network node, such as radio network node 130, depicted in FIG. 1b). The radio network node 130 may be, e.g., comprised in a Radio Access Network of the telecommunications system. That is, the radio network node 130 may be a transmission point such as a radio base station, for example a gNB, an eNB, or any other network node with similar features capable of serving a wireless device, such as a user equipment or a machine type communication device, in the computer system 100. In typical examples, the radio network node 130 may be a base station, such as a gNB or an eNB. In other examples, the radio network node 130 may be a distributed node, such as a virtual node in the cloud 115, and may perform its functions entirely on the cloud 115, or partially, in collaboration with a radio network node.

The telecommunications system may cover a geographical area, which in some embodiments may be divided into cell areas, wherein each cell area may be served by a radio network node 130, although, one radio network node 130 may serve one or several cells. In the example of FIG. 1, the cells are not depicted to simplify the figure. The radio network node 130 may be of different classes, such as, e.g., macro eNodeB, home eNodeB or pico base station, based on transmission power and thereby also cell size. In some examples, the radio network node 130 may serve receiving nodes with serving beams. The radio network node 130 may be directly connected to one or more core networks.

Any of the first node 111, the second node 112, and/or any of the nodes comprised in the computer system 100 may support one or several communication technologies, and its name may depend on the technology and terminology used.

A device 140 may be comprised in the telecommunication network. The device 140 comprised in the computer system 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. The device 140 comprised in the telecommunications system may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, sensor, IoT device, or any other radio network unit capable of communicating over a radio link in a communications system. The device 140 comprised in the telecommunications system is enabled to communicate wirelessly in the telecommunications system. The communication may be performed e.g., via a RAN, and possibly the one or more core networks, which may be comprised within the telecommunications system.

The first node 111 may be configured to communicate within the computer system 100 with the second node 112 over a first link 141, e.g., a radio link, or a wired link. The first node 111 may be configured to communicate within the computer system 100 with the radio network node 130 over a second link 142, e.g., a radio link, or a wired link. The second node 112 may be configured to communicate within the computer system 100 with the radio network node 130 over a third link 143, e.g., a radio link, or a wired link. The radio network node 130 may be configured to communicate within the computer system 100 with the device 140 over a fourth link 144, e.g., a radio link.

Any of the first link 141, the second link 142, the third link 143 and the fourth link 144, may be a direct link or may be comprised of a plurality of individual links, wherein it may go via one or more computer systems or one or more core networks in the computer system 100, which are not depicted in FIG. 1, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 1.

In general, the usage of “first”, “second”, “third” and/or “fourth” herein may be understood to be an arbitrary way to denote different elements or entities, and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

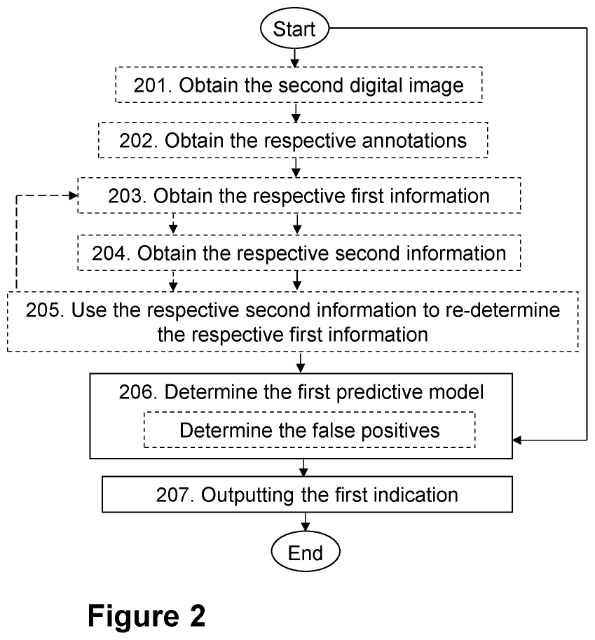

Embodiments of a computer-implemented method, performed by the second node 112, will now be described with reference to the flowchart depicted in FIG. 2. The method is for handling object identification. The second node 112 operates in the computer system 100.

Several embodiments are comprised herein. In some embodiments all the actions may be performed. In some embodiments, some actions may be optional. In FIG. 2, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description.

### Action 201

As was mentioned earlier in relation to the description of FIG. 1, the second node 112 may be understood to be a node having a capability to train the first predictive model 122. The first predictive model 122 may enable to identify one or more objects, e.g., common objects such as cars, in different environments, in digital images. Particularly, as will be described later, the first predictive model 122 may be trained to indicate a respective identification of one or more first objects in a first digital image to be input into the first predictive model 122.

In order to ultimately lead to that, in this Action 201, the second node 112 may obtain, a digital image, referred to herein as a second digital image. The first digital image may be understood as a digital image used as input to the first predictive model 122 once it may have been trained, whereas a second digital image may be understood as a digital image used as input to the first predictive model 122 during its training. A digital image, such as any of the first digital image and the second digital image, may be, for example, an RGB image. Any of the digital images may originate from a visual camera, e.g., a digital camera. The term digital image, RGB-image or original image used in this document may be understood to refer to a photo from a normal two dimensional (2D) camera for visual light. However, embodiments herein may be understood to benefit from more information about a given scene. Hence, a digital image such as any of the first digital image and the second digital image described herein, may be an image from a camera system providing depth information, e.g., an RGB(D) image, stereo images or data outside of the visual part of the spectrum may be understood to be beneficial for the method and may replace or complement an RGB image. Any of the digital images, e.g., the RGB(D) image, or images, may have been captured with a camera.

The second digital image may be part of a set of information that the second node 112 may use to train the first predictive mode 122. It may be understood that the second node 112 may in fact train the first predictive mode 122 with a plurality of sets of information, wherein each of the sets of information may comprise a respective second digital image. Each of the sets of information may comprise the respective second digital image and other information associated with it, which may include additional images, as will be described in later actions.

Accordingly, in this Action 201, the second node 112 may obtain, for each of the sets of information, the respective second digital image. That is, in this Action 201, the second node 112 may be understood to obtain one or more respective second digital images.

The obtaining in this Action 201 may be understood as receiving the respective second digital image from a camera, another node or a memory storage.

By, in this Action 201, obtaining the respective second digital image, the second node 112 may be enabled to then train the first predictive model 122 to identify one or more objects in digital images.

### Action 202

The obtained respective second digital image may be labelled, that is, annotated.

In this Action 202, the second node 112 may obtain, for each of the sets of information, respective annotations. The respective annotations of the respective second digital image may indicate a respective identification of one or more respective second objects in the respective second digital image. There may be a plurality of annotation types. The annotation types may include both object detection and semantic segmentation supporting the understanding that certain areas may be, e.g., overexposed, but still e.g., a stool or still the same car.

The respective annotations may be obtained in this Action 202 by receiving them from a human, which may have annotated the respective second digital images obtained from a camera, or by retrieving them from another source, such as a memory storage.

The respective annotations of the respective second digital image may also indicate respective information indicating a respective state of the identified one or more respective second objects. This information indicating the respective state of the identified one or more respective second objects may be referred to herein as “respective third information”.

To give a label for the state of the one or more respective second objects, e.g., cars, may be additionally tagged with certain semantics such as the state, e.g., dirty, wet, rusty. A possible extension of the state labelling may be to identify physical properties such as the type of materials or surface structure, e.g., glossy or matt, etc.

The state labelling may be understood as a description of the object not changing what the object is, but offering a sublevel describing it further. An example may be to give the object car states such as dirty, rusty, wet or clean. The state may also be very specific and introduced for a system, addressing a specialized purpose. An illustrative example of this may be that for the object “spinach leaf”, the states may be “healthy”, when the spinach leaf may be green and glossy, “thirsty”, if being dry makes the spinach leaf be green and matt, and “hungry”, if malnourishment makes the spinach leaf be yellowish and matt. Even if the labelling may be time consuming and cumbersome, the state may need to be labelled to a set of respective second digital images before training. To get a large set of images labelled with object and state, a three dimensional (3D) model may be used. In the spinach example, this may require that the texture for the different states may be defined, by measurements or otherwise, so that a set of labelled images may be generated, e.g., one annotated image per respective second digital image, corresponding to a plurality of sets of information. This set may include different illumination and variation of the shape and form of the leaves.

The respective annotations of the respective second digital image may be used later, in Action 203 in order to obtain respective first information for the respective second digital image, which respective first information may comprise information of one or more light sources in the respective second digital image. For that purpose, the obtained respective second digital images may be understood to need to include a variety of illumination types, such as indoor, e.g., fluorescent tube lighting, and outdoor, for example, full day sun, e.g., 6000 Kelvin (K), sunset light, e.g., 3000 K and other variants such as, e.g., cloudy, in shadow, partly in shadow, etc. With these other types of information, the second node 112 may gain in efficiency of the calculations.

According to the foregoing, the respective annotations may be understood as the object or material ground truth, potentially including object state e.g., “dirty car” “glossy window” and also over/under-exposed/saturated.

By obtaining the respective annotations in this Action 202, second node 112 may then be enabled to train the first predictive model 122 to identify one or more objects in digital images such as the first digital image with higher accuracy e.g., less false positives and false negatives and more detailed or in-depth knowledge of the one or more objects. Furthermore, the second node 112 may be enabled to train the first predictive model 122 to learn the semantic segmentation, object label, object state, etc, so that it may then also identify and provide this information as output of any objects identified in digital images used as input.

### Action 203

In this Action 203, the second node 112, for each of the sets of information, obtains respective first information.

The respective first information indicates one or more respective first properties of an illumination in the respective second digital image.

The obtaining in this Action 203 may be understood as determining, calculating, deriving, estimating or similar itself, or receiving the respective first information from another node, sensors, or a human, or, retrieving it from a memory storage.

The respective first information may be determined by the second node 112 based on the obtained respective second digital image in Action 201.

In some embodiments, obtaining the respective first information in this Action 203 may comprise determining one or more respective light sources of the illumination in the respective second digital image. The light source(s) properties may be calculated using the input respective second digital image using existing methods. In such embodiments, the obtaining of the respective first information in this Action 203 may comprise to calculate, with existing tools, information about the source of illumination for the respective second digital image obtained.

The one or more respective first properties may comprise detailed parameters regarding light source information such as the number of light sources, intensity, spectrum, size, position (x, y, z), direction (φ, θ), cone angle (α) of the of the sources or much lower resolution information categorizing/binning different types of lighting situations in a more limited number of categories, which may later facilitate the ML training. The second node 112 may then connect the obtained respective first information to each respective second digital image. One of the existing methods that may be used may be a deep neural network which may calculate a dominant light direction from a single RGB-D image. Other methods may be used.

Other than by using a machine learning technique, the second node 112 may obtain the light source information directly from a 3D graphics engine, such as for example, Unity, based on sensors in for example, a Head Mounted Display (HMD), or, for outdoor scenes, concluded based on geo-positioning in combination with satellite data.

The light source parameters may be binned or categorized, e.g., indoor diffuse light source, indoor spot source, outdoor cloudy, outdoor sunny, outdoor dusk. Other types of information such as environmental information or, time of day, time of year, geographic position may also be added to the respective second digital image to improve the input lightening information.

The existing deep learning approaches may require certain computational resources to predict a light source direction, such as processing power, memory, storage, bandwidth and specific libraries may have their own computational demands. On other hand, for the light-weight approach where a ‘basic’ light information may be sufficient, the second node 112 may just use the above mentioned information, that is, other types of information such as environmental information or, time of day, time of year, geographic position. In other words, in some examples, a software implementation that may not require too much processing power and may use simpler data inputs may be used, by for example, limiting the light source description to a few parameters and/or low resolution, indoor, outdoor, dusk . . . and an angular direction.

With these other types of information, the second node 112 may also gain in additional information, with respect to the currently limited deep learning models which may be available to predict the light-source. The current state-of-the-art deep learning models do not provide information about brightness or light intensity, and the above information that is, the other types of information such as environmental information or, time of day, time of year, geographic position, may complement the understanding of the light source, e.g., sunset light intensity vs. daylight intensity.

By obtaining the respective first information indicating the one or more respective first properties of the illumination in the respective second digital image in this Action 203, the second node 112 may then be enabled to use the respective first information as input to the first predictive model 122 in order to train it to identify the one or more objects in the digital images.

### Action 204

In in this Action 204, the second node 112 may obtain, for each of the sets of information, respective second information. The respective second information indicates one or more respective second properties of a respective reflectance of the respective second digital image. Reflectance may be understood as a ratio of a light intensity reflected by an object to a light intensity incident on that object. Reflectance may be understood to quantify how much light may be reflected by surfaces, and it may vary depending on the wavelength of the incident light, the angle of incidence, and the properties of the material of the object. Reflectance values may typically range from 0, for no reflection, to 1, for complete reflection, and they may be understood to have an effect in the appearance, color, and brightness of objects in various lighting conditions.

The one or more second properties of the respective reflectance may be understood to describe how objects may interact with incident light. The one or more second properties may include terms, such as albedo and may be dependent on wavelength and incident angle. The one or more second properties may, in some examples, comprise texture properties.

The obtaining in this Action 304 may be understood as determining, e.g., calculating, deriving, estimating or similar, or receiving the information from another node or memory storage. In addition to what has been described so far, the generation of images for training a 3D engine, such as Unity, may be used to create sets of images with all the input. That is, the respective second digital image, e.g., RGB-image, the respective annotations, that is, semantic information, the respective first information, e.g., the light source, and the respective second information, e.g., the object reflective properties may be obtained by being generated in the 3D engine.

The reflectance may be represented as a map. A reflectance map may be understood as a representation of reflectance values across a spatial domain, typically related to the surface of an object or a scene. A reflectance value may be understood as a portion of light, e.g., in percentage, that may be reflected in a surface. A spatial resolution of the map may be as low as one single value for an object or a specific segment of the object, or as high as a value for every pixel. The obtaining in this Action 304 of the respective second information may comprise determining a respective reflectance map of the respective second digital image. The respective second information may be determined, by the second node 112, based on the obtained respective first information.

Herein, the reflectance map may be also referred to as a “reflectance image”. The term “reflectance image” may be understood to refer to a representation of spatially represented reflectance values, possibly with the same resolution as the original image but more likely with a lower resolution. The “reflectance image” may not be a representation of reflected light in a specific illumination situation as proposed by others, e.g. [5], but an estimation of the reflective properties of the objects in the scene. That is, a reflectance image may be understood to be independent of illumination. If calculated correctly, the reflectance image may be understood to not change when illumination does so.

The reflectance map or reflectance image may be understood as an estimation of the one or more respective second properties of the respective reflectance.

To obtain the reflectance image may comprise performing a reverse calculation of a reflection coefficient vector, where the input data may be the original respective second digital image obtained in Action 201, any labeling of objects and/or segments obtained in Action 202, and the illumination description calculated in Action 203. That is, if the outcome of a certain computation, such as the lit appearance of an object in an image, and a model of how light interacts with surfaces is known, it may be possible to perform “reverse calculations” to estimate the original properties of that surface, such as its reflectance, before it was illuminated. Another way may be to divide the amount of light that falls onto a surface and the amount that is reflected away.

A “reflectance image” may have a single reflectance value per area unit, here called pixel, or a reflectance value per wavelength with a certain bandwidth R=R(λ) creating a full reflective spectrum per pixel. It may be assumed that splitting the reflectance in 3 wavelength groups giving 3 values per pixel, may often be sufficient for most uses. The “reflectance image” may be used in way parallel to how a texture map may be used in a 3D rendering program, such as e.g., Unity, when rendering an object. In its simplest form, the reflectance may be a single value, black and white (B&W), resulting from dividing incoming intensity with the reflected value in the original first digital image. More advanced reflectance mapping algorithms may be used for specific purposes e.g., Hyperspectral images of natural scenes 3002 (manchester.ac.uk), where every pixel may have a reflectance value for every 10 nm between 400-700 nm.

In some particular embodiments, the respective second information may be determined, by the second node 112, based on the respective first information determined by the second node 112. From the obtained respective second digital image in Action 201 and the respective first information obtained in Action 203, the second node 112 may then obtain a respective reflectance image.

The second node 112 may obtain the respective reflectance map within the input data, that is, the respective second digital image obtained in Action 201, the respective annotations obtained in Action 202, and the respective first information obtained in Action 203, and in the context of the full chain of the process. This may be performed by the second node 112 using the RGB data of the respective second digital image and the available knowledge of the light sources.

The whole process may be understood to be similar to what may be called reverse texture mapping, referring to the methods for applying materials to objects in a three dimensional (3D) rendering engine Software (SW), such as e.g., Unity.

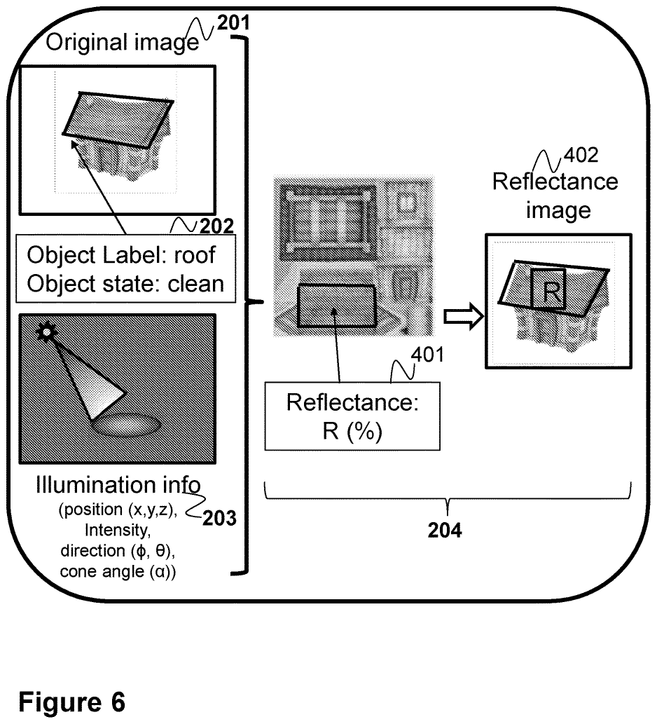

An illustration of this Action 204 may be found in FIG. 6.

By obtaining the respective second information in this Action 204, the second node 112 may be enabled to use the respective second information as input to the first predictive model 122 in order to more efficiently train it to identify the one or more objects in the digital images with higher accuracy. Adding reflectance information to the input of the first predictive model 122 may enable to enhance the robustness to lighting variations, improve object recognition, provide better generalization, etc. Reflectance may be understood to be a property of the materials of the objects and may not be dependent of the environment, especially the illumination.

### Action 205

In some examples, the respective second digital image may comprise one or more highly reflective objects, such as, for example, a water puddle. Such objects may reflect light, as well as other objects. In such examples, the light source may be wrongly estimated if the reflectance from objects in the respective second digital image is unknown or factored in. Furthermore, during an inference phase of the ML, the objects reflected on highly reflective surfaces may be wrongly identified as additional objects in an image.

In this Action 205, e.g., during the inference phase of the ML, the second node 112 may optionally use the obtained respective second information, e.g., the “reflectance image”, to redetermine the obtained respective first information, e.g., the light source. Accordingly, in this Action 205, the input image, the “reflectance image” and the light source properties may be used to improve the calculation of the light source properties and further improve the “reflectance Image” in an iterative way. This is represented by the dashed arrow from Action 205 to Action 203 in FIG. 2.

After the light source information may have been obtained in Action 203, the second node 112 may be enabled to know that highly reflective objects may not be an original source of the light in a respective second digital image, and, during the inference phase, the reflected objects may be understood to not have to be detected as real ones. Thus, after applying this knowledge in a first iteration, the second node 112 may correct the prediction of the respective second information, e.g., the reflectance image, in a second iteration. This may be performed as follows: after the reflectance map may have been calculated in Action 204, the second node 112 may need to normalize it and quantify the surface roughness, e.g., matt or glossy.

Then, the second node 112 may determine a threshold value that may distinguish between high and low reflectance. The threshold value may be determined based on the specific requirements of the application or the characteristics of the scene the second node 112 may be analyzing. Later, the second node 112 may apply the threshold value to segment the reflectance map into regions of high and low reflectance considering the level of gloss. Next, the second node 112 may define if there may be prediction within a high reflectance area, for example, bounding box coordinates. If so, the second node 112 may remove the prediction within this area and may not treat this area as a light source. A bounding box may be understood as a rectangular box used to define the location and rough size/shape of an object within an image. For predictions made by object detection models, the bounding box may enclose the region where the model may believe an object of interest may reside. To “remove prediction” may be understood to mean that the bounding box, and its associated class label and confidence score, that may have been incorrectly predicted by the model may be disregarded or not included in the final presentation of the detected object.

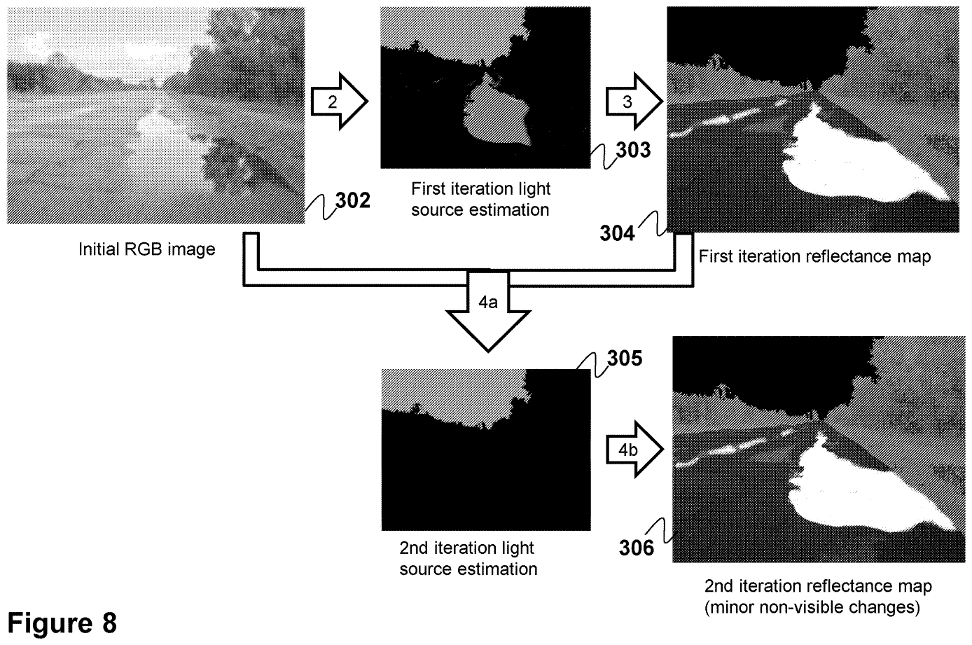

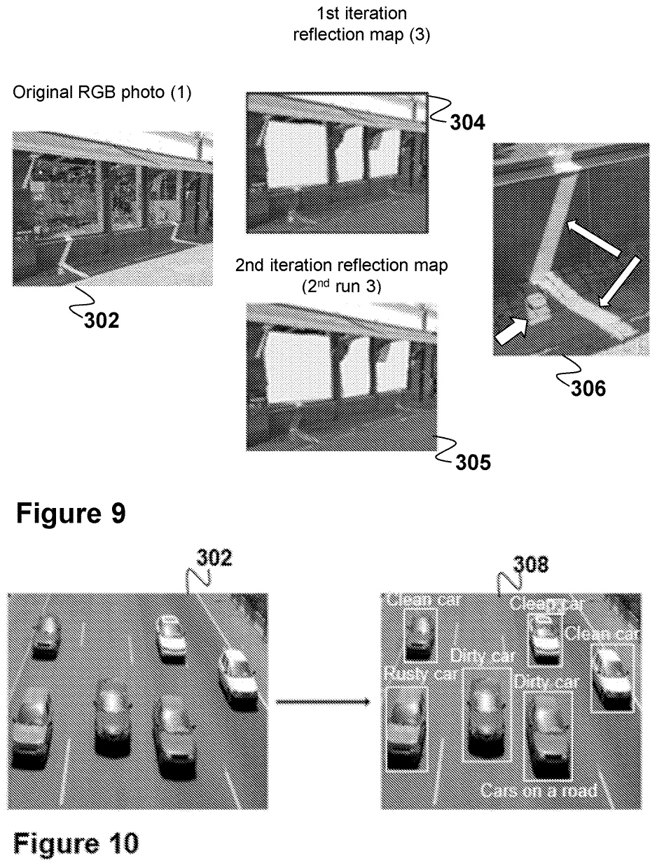

Explained with other words, in a first iteration, the incoming light may be calculated in Action 203 and the high reflectance areas may be identified in Action 204, especially those with high gloss, such as windows, giving specular reflections. In a second iteration, the reflectance of the bright areas illuminated from the glossy surfaces may be reestimated. This may enable the second node 112 to give such glossy surfaces the same properties as the others, thus reducing the risk for misinterpretation from the Object Detection (OD) algorithms. Action 205 is illustrated with two different examples in FIG. 8 and FIG. 9.

By using the obtained respective second information to redetermine the obtained respective first information in this Action 205, the second node 112 may then be enabled to determine, for at least the respective second digital image in one set of the plurality, based on the redetermined respective first information, whether or not one or more candidate objects initially identified in the respective second digital image, e.g., during the inference phase, may be one of: false positives and false negatives. The determined first predictive model 122 may be trained to then enable the second node 112 to identify the one or more first objects in the first digital image to be input into the first predictive model 122 excluding false positives or false negatives.

For example, having an image with a reflectance surface, the objects, which may include subjects, reflected from such surface may not be detected by the first predictive model 122. Thus, if counting trees, the risk of also counting the reflection of trees in the puddle may be reduced using the first predictive model 122, as trained by the second node 112 according to embodiments herein.

Furthermore, as a further advantage, having an image with multiple objects of the same type, e.g., cars, the second node 112 may more easily predict their respective states with the first predictive model 122. Accordingly, instead of just getting the object label, “car”, the output of the first predictive model 122 may also include different states of the car that may affect reflection properties, such as e.g., “rusty”, “dirty”, “clean”, “wet” etc.

### Action 206

In this Action 206, the second node 112 determines, using machine learning, the first predictive model 122 to identify the one or more objects in the digital images. The determining in this Action 206 of the first predictive model 122 comprises training the first predictive model 122 using a plurality of sets of information. Each of the sets of information comprises: i) a respective second digital image, ii) the respective annotations of the respective second digital image indicating: a) the respective identification of the one or more respective second objects in the respective second digital image, and b) the respective third information indicating the respective state of the identified one or more respective second objects, iii) the respective first information indicating the one or more respective first properties of the illumination in the respective second digital image, and iv) the respective second information indicating the one or more respective second properties of the respective reflectance of the respective second digital image.

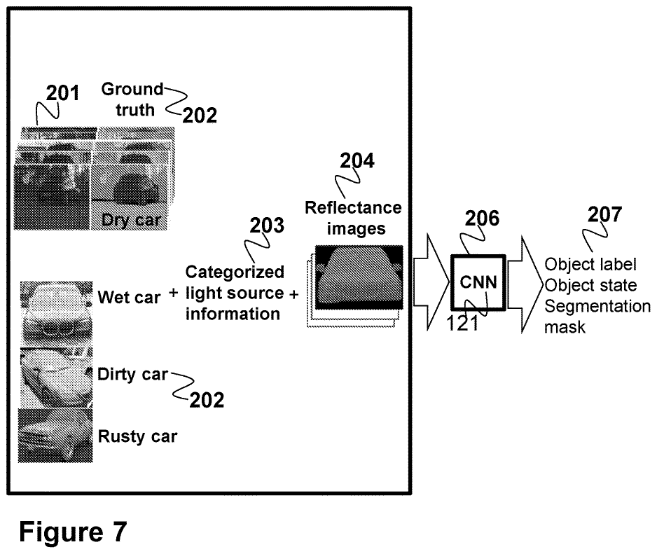

After having performed Action 201, Action 202, Action 203, Action 204 and, optionally, Action 205, there may be, all based on one original second digital image, e.g., an RGB-image, a set of respective, semantic, light source and reflective properties knowledge. A plurality of such sets may be used by the second node 112 for a machine learning process to obtain, in this Action 206, the first predictive model 122 of object detection, object state and semantic segmentation, an illustration of which will be described later in relation to FIG. 7.

To perform the determining using machine learning in this Action 206, a convolutional neural network (CNN) may be used as an example of the artificial neural network 121. A CNN may be understood as a class of artificial neural network most commonly applied in deep learning, to analyze visual images. For the CNN choice, a model such as a Mask Region-Based CNN (R-CNN) may be used. Mask R-CNN may be understood as an extension of Faster R-CNN and may be understood to work by adding a branch for predicting an object mask in parallel with an existing branch for bounding box and class recognition. An object mask may be understood as a binary map that may delineate the pixels of a specific object instance in the input image, distinguishing it from other instances and the background. This mask may enable pixel-level segmentation of individual object instances.

Mask R-CNN may be easy to generalize to other tasks. That is, the underlying architecture may be understood to be flexible and may be used as a foundation for various computer vision challenges. Additionally, the selection of the model may be extended to incorporate multimodal attention mechanisms. Multimodal attention mechanisms may be understood as methods that may allow a machine learning model to dynamically weigh and focus on relevant portions of input data from different modalities, such as visual, auditory, and textual sources. These mechanisms may enable the model to allocate varying attention across different types of input data, thereby enhancing its ability to capture inter-modal relationships and improve overall performance in tasks where diverse data sources may be integrated.

During the data processing step performed in Action 203, the respective first information, e.g., the light source information, may be represented numerically or categorically. The respective first information, that is, the light source information, may integrate the light source data directly into the neural network, meaning that it may be used as input alongside the respective second digital image, e.g., the RGB image, and the respective second information, e.g., the reflectance map data. This may be performed by concatenating the respective first information with the respective second digital image data before inputting it into the first predictive model 122, or by inputting it into its own separate layer of the first predictive model 122. Alternatively, in a second type of architecture, the second node 112 may use the respective first information as an auxiliary input, e.g., put into the first predictive model 122 separately from the respective second digital image and the respective second information, e.g., the reflectance map data, usually at a later stage of the first predictive model 122. For example, the CNN may process the respective second digital image data and the respective first information through a separate branch of the network, such as a fully connected layer. The outputs from these separate branches may then be combined, e.g., concatenated, and passed through further layers of the first predictive model 122. The process of merging or joining the feature vectors from these separate branches into one unified feature vector may be referred to herein as a combined feature vector. This may be performed in various ways, with concatenation being one common method.

Depending how the respective first information may be fed, the feature extraction by the CNN may be performed, either using all the respective second digital images obtained in Action 201, the respective annotations obtained in Action 202, the respective first information obtained in Action 203 and the respective second information obtained in Action 204, or the feature extraction may be performed first, based on the respective second digital image and the respective second information, and then concatenated with the respective first information before the CNN being passed to the next stage of the neural network. Feature extraction may be understood to refer to a process by which the neural network may identify and extract significant patterns or characteristics from the images.

The choice of the architecture, with all information provided together, may be suitable when the respective first information may be expected to have a significant impact on the performance of the first predictive model 122 and may be considered from the early stages of feature extraction. By providing all the information together, that is, the respective second digital image and the respective second information, and the respective first information, the first predictive model 122 may learn to extract features that may be directly influenced by the light source. This architecture may be expected to capture more complex interactions between the light source, image content, and reflectance, resulting in improved detection and segmentation performance.

The second type of architecture may be considered to be appropriate when the light source information may be considered as supplementary or additional input that may complement the respective second digital image and the respective second information, rather than being the primary driver of feature extraction. One such scenario may be when the light source information may remain relatively constant or may have minimal impact on the variations in the scene depicted in the respective second digital image. The second node 112 may first extract features that may be less affected by the lighting conditions, e.g., shape, texture, other visual characteristics of the objects depicted, but may still be influenced by lighting variations. Here, the second node 112 may reuse the light source extracted earlier or redo a new extraction. This may reduce computational complexity. However, the light source information may still contribute to the overall understanding of the scene and may potentially improve the performance of the first predictive model 122.

A loss function may be understood as a mathematical function that may quantify the difference between the predicted output and the actual output or target values in machine learning and optimization algorithms. The goal during training may be understood to be to minimize this difference, thereby making the predictions of the model as accurate as possible.

For the loss function, to predict the object state, which may be understood to be a classification task, the second node 112 may use a soft max activation in the final layer of the neural network, and cross-entropy loss as the loss function.

The combined feature vector may enable the first predictive model 122 to learn more complex representations. This may improve the ability of the first predictive model 122 to improve its detection and segmentation performance.

In some embodiments, the determining in this Action 206 of the first predictive model 122 may comprise performing the method 201, 202, 203, 204, 206 iteratively during a training phase, during which the first predictive model 122 may be trained with a first plurality of sets of information during a first set of iterations, and an inference phase, during which the trained first predictive model 122 may be used over one or more second iterations to identify objects on a second plurality of sets of information. Performing the method 201, 203, 204, 206 iteratively during the inference phase may exclude the obtaining in Action 202 of the respective annotations, and may further comprise performing the redetermining of Action 205. During the training phase, the first predictive model 122 may be trained to learn the semantic segmentation, object label, object state, etc of the one or more objects in the digital images using both, the respective second digital images, e.g., RGB, first information, e.g., light source information and second information, e.g., reflectance data, and as input.

The first predictive model 122 may be trained to indicate a respective identification of the one or more first objects in a first digital image to be input into the first predictive model 122. The first digital image may be understood as a new or fresh digital image. The first digital image may lack respective annotations. The first predictive model 122 may be trained to also indicate third information indicating a respective state of the identified one or more first objects.

In embodiments wherein the second node 112 may have performed Action 205, the determining in this Action 206 of the first predictive model 122 may be based on the redetermined respective first information.

In embodiments wherein the second node 112 may have performed Action 205, e.g., during the inference phase, the determining in this Action 206 of the first predictive model 122 may further comprise determining, for at least the respective second digital image in one set of the plurality, based on the redetermined respective first information, whether or not one or more candidate objects initially identified in the respective second digital image may be one of: false positives and false negatives. The determined first predictive model 122 may be trained to identify the one or more first objects in the first digital image to be input into the first predictive model 122 excluding false positives or false negatives.

By determining the first predictive model 122 to identify the one or more objects in the digital images in this Action 207, the second node 112 may then be enabled to provide the trained model to the first node 111 which may then use the first predictive model 122 to identify one or more objects in digital images. This may be understood to be performed with higher accuracy than existing approaches, and provide further information, e.g., the state of the identified objects, than existing approaches. By using as input the respective annotations, the respective first information and the respective second information, the second node 112 may be enabled to achieve more precise object detection, improved semantic segmentation, and provide better understanding of the state of the objects. As stated earlier, the appearance of an object in an RGB image may be greatly influenced by the characteristics of the ambient light, such as its intensity, direction, and color. For instance, an object illuminated under bright sunlight may have totally different RGB characteristics compared to when it is under artificial light or in the shadows. By factoring in such variations in lighting conditions in the determining of the first predictive model 122, the performance and reliability of object detection by the first predictive mode 122 may be improved, leading to further precise identifications and classifications.

The determined first predictive model 122 may enable the first node 111 to, using a set of input images, light source input and a “reflectance image” as input to the first predictive model 122, to obtain object labels, object state/types and semantic masks. Higher-level knowledge of the state of an object may be achieved using reflective and surface property knowledge about the object, e.g., a low reflectance car, may be a dirty car or a glossy face may be a sweaty face.

Finally, applying the higher-level knowledge to the already detected objects may support reinterpretation of the object. For example, a highly reflective part of a scene, may be a mirror, a water puddle or a window and a pile of mud may be a very dirty car or a pig.

Advantageously, introducing knowledge of object reflectance properties in an image-based object detection system may allow for a more exact way of identifying complete and segmented parts of objects from a digital image, e.g., an RGB image, without adding requirements of additional hardware.

### Action 207

In this Action 207, the second node 112 outputs a first indication of the determined first predictive model 122 in Action 206. The first indication may be, for example, a mathematical formula corresponding to the first predictive model 122.

In some embodiments, the first indication may be output to the first node 111 operating in the computer system 100. The first indication may enable the first node 111 to run or execute the first predictive model 122.

In some examples wherein the first node 111 may be a node capable to run the first predictive model 122, but not to train it, the first indication may be the first predictive model 122. In such examples, outputting in this Action 207 may comprise providing the first indication, e.g., via the first link 141, to the first node 111. Outputting in this Action 207 may alternatively, or additionally, comprise displaying the first indication on an interface of the first node 111.

By outputting the first indication in this Action 207, the second node 112 may enable to provide one or more objects identified in digital images. In some examples, the first indication may be one or more of a label of any object identified in a respective second image, a state of the object and a segmentation mask. A segmentation mask may be understood as a binary or multi-class image where each pixel may be assigned a label indicating its category or class. In the context of image processing and computer vision, this mask may help to delineate specific objects or regions within the original image, allowing for a more granular understanding of its contents.

By outputting the first indication in this Action 207, the second node 112 may enable the first node 111 to then use the first predictive model 122 to identify one or more objects in digital images.

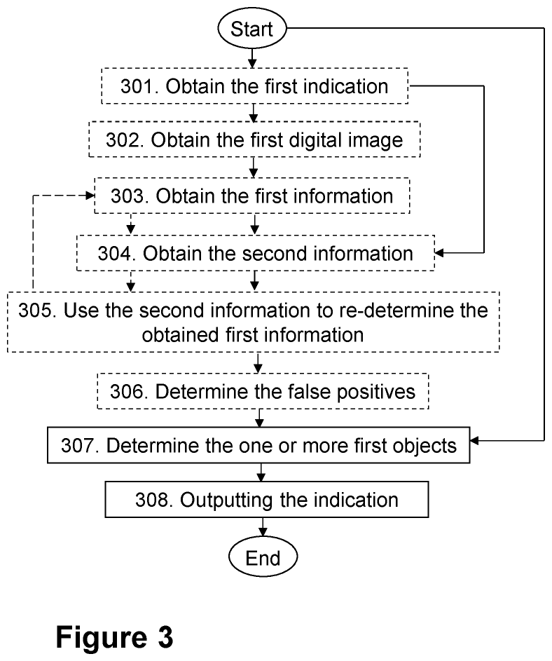

Embodiments of a computer-implemented method, performed by the first node 111, will now be described with reference to the flowchart depicted in FIG. 3. The method is for handling object identification. The first node 111 operates in the computer system 100.

Several embodiments are comprised herein. In some embodiments all the actions may be performed. In some embodiments, some actions may be optional. In FIG. 3, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. The detailed description of some of the following corresponds to the same references provided above, in relation to the actions described for the second node 112, and will thus not be repeated here. For example, a digital image may be, e.g., an RGB image or RGB(D) image.

### Action 301

As described earlier in relation to FIG. 1, the first node 111 may be understood as a node having a capability to execute, run, or use, the first predictive model 122, which may have been trained by the second node 122. The first predictive model 122 may enable to identify one or more objects, e.g., common objects such as cars, in different environments, in digital images.

In this Action 301, the first node 111 may obtain the first indication of the first predictive model 122. The first indication may be obtained from the second node 112 operating in the computer system 100. The first indication may enable to run or execute the first predictive model 122. The first indication may be, for example, a mathematical formula corresponding to the first predictive model 122.

In examples wherein the first node 111 may be a node capable to run the first predictive model 122, but not to train it, the first indication may be the actual formula. In such examples, obtaining in this Action 301 may comprise receiving the first indication, e.g., via the first link 141, from the second node 112. Obtaining in this Action 301 may alternatively, or additionally, comprise retrieving the first indication from a memory storage.

In examples wherein the first node 111 may be the same node as the second node 112, the obtaining in this Action 301 may comprise retrieving the first indication from the memory storage.

By obtaining the first indication in this Action 301, the first node 111 may then be enabled to use the first predictive model 122 to identify one or more objects in digital images.

### Action 302

In this Action 302, the first node 111 may obtain the first digital image. The first digital image may be, for example, an RGB image or RGB(D). The first digital image may originate from a visual camera, e.g., a digital camera.

The obtaining in this Action 302 may be understood as receiving the first digital image from the camera, another node or a memory storage.

It may be understood that, in some examples, this Action 302 may comprise obtaining a set of digital images that may comprise the first digital image.

The obtaining in this Action 302 may be performed as described earlier in Action 201.

By, in this Action 302, obtaining the first digital image, the first node 111 may be enabled to then use the obtained first predictive model 122 to identify one or more first objects in the obtained first digital image.

### Action 303

In this Action 303, the first node 111 may obtain first information. The first information may indicate one or more first properties of an illumination in the first digital image, that is, in the obtained first digital image. The first information may be understood to be equivalent to the respective first information, but with respect to the first digital image.

In some embodiments, the first information may be determined by the first node 111 based on the obtained first digital image.

In some embodiments, obtaining the first information in this Action 303 may comprise determining one or more light sources of the illumination in the first digital image. The light source(s) properties may be calculated using the input first digital image using existing methods.

The obtaining in this Action 303 may be understood as determining, e.g., calculating, deriving, estimating or similar, or receiving the information from another node or memory storage. The obtaining in this Action 303 may be performed as described earlier in Action 203.

By obtaining the first information indicating the one or more first properties of the illumination in the first digital image in this Action 303, the first node 111 may then be enabled to use the first information as input to the first predictive model 122 in order to identify the one or more first objects in the first digital image.

### Action 304

In this Action 304, the first node 111 obtain second information. The second information may indicate one or more second properties of a respective reflectance of the first digital image, that is, the obtained first digital image. The second information may be understood to be equivalent to the respective second information, but with respect to the first digital image. According to examples of embodiments herein, a single RGB image may be the base for calculating reflectance.

The obtaining in this Action 304 may be understood as determining, e.g., calculating, deriving, estimating or similar, or receiving the information from another node or memory storage. The obtaining in this Action 304 may be performed as described earlier in Action 204. The obtaining in this Action 304 of the second information may comprise determining a reflectance map of the first digital image. The second information may be determined, by the first node 111, based on the obtained first information.

In some particular embodiments, the second information may be determined by the first node 111, based on the first information determined by the first node 111.

By obtaining the second information indicating the one or more second properties of the respective reflectance of the first digital image in this Action 304, the first node 111 may then be enabled to use the second information as input to the first predictive model 122 in order to identify the one or more first objects in the first digital image. The first node 111 may be further enabled to use the second information to redetermine the first information in the next Action 305, similarly to how it was explained in Action 205.

### Action 305

In this Action 305, the first node 111 may use the obtained second information to redetermine the obtained first information, similarly to how it was explained in Action 205.

By using the obtained second information to redetermine the obtained first information in this Action 305, the first node 111 may then be enabled to determine, based on the redetermined first information, whether or not one or more candidate objects initially identified in the first digital image may be false positives and/or false negatives. The one or more first objects that may be later determined may then exclude any determined false positives or any determined false negatives. The determined first predictive model 122 may be trained to then enable the first node 111 to identify the one or more first objects in the first digital image to be input into the first predictive model 122, excluding false positives or false negatives.

### Action 306

In this Action 306, the first node 111 may determine, based on the redetermined first information, whether or not one or more candidate objects initially identified in the first digital image may be one of: false positives and false negatives.

Determining may be understood as calculating, estimating, deriving, or similar, or obtaining or receiving from another node.

By determining, based on the redetermined first information, whether or not one or more candidate objects initially identified in the first digital image may be one of: false positives and false negatives in this Action 306, the first node 111 may be enabled to identify the one or more first objects in the first digital image with higher accuracy.

### Action 307

In this Action 307, the first node 111 determines, using the first predictive model 122 to identify one or more objects in digital images, the one or more first objects in the first digital image. The determining in this Action 307 is based on: i) the first information indicating the one or more first properties of the illumination in the first digital image, and ii) the second information indicating the one or more second properties of the respective reflectance of the first digital image.

Determining the one or more first objects in the first digital image using the first predictive model 122 to identify one or more objects in digital images may be understood as executing or running the first predictive model 122

In some embodiments, the determining in this Action 307 of the one or more first objects may be based on the redetermined first information.

In embodiments wherein Action 306 may have been performed, the determined one or more first objects may exclude determined false positives or determined false negatives.

By using the first predictive model 122 in this Action 307, the first node 111 may be enabled to identify the one or more first objects in the first digital image with higher accuracy than existing approaches, and provide enhanced object, e.g., scene, understanding, robustness in varied lighting conditions, and better generalization to unseen data, than existing approaches, enabling new applications, e.g., new use cases. By using as input the first information and the second information, the first node 111 may be enabled to achieve more accurate object detection, improved semantic segmentation, and provide better understanding of the state of the one or more first objects. The determined first predictive model 122 may enable the first node 111 to, using a set of input images, light source input and a “reflectance image” as input to the first predictive model 122, to obtain object labels, object state/types and semantic masks. Higher-level knowledge of the state of an object may be achieved using reflective and surface property knowledge about the object, e.g., a low reflectance car, may be a dirty car or a glossy face may be a sweaty face.

Finally, applying the higher-level knowledge to the already detected objects may support reinterpretation of the object. For example, a highly reflective part of a scene, may be a mirror, a water puddle or a window and a pile of mud may be a very dirty car or a pig.

Advantageously, introducing knowledge of object reflectance properties in an image-based object detection system may allow for a more exact way of identifying complete and segmented parts of objects from a digital image, e.g., an RGB image, without adding requirements of additional hardware.

### Action 308

In this Action 308, the first node 111 initiates outputting an indication of the determined one or more first objects. The output indication may be understood to be a second indication. The indication, that is, the second indication, may indicate: a) a respective identification of the one or more first objects, and b) third information indicating a respective state of the identified one or more first objects.

In some examples, the second indication may be one or more of a label of any first object identified in the first digital image, a state of the first object and a segmentation mask.

Initiating may be understood as triggering, enabling, beginning, or similar.

Outputting in this Action 308 may be understood as displaying, e.g., on an interface or sending, for example, via the a link to another node.

By initiating outputting, the second indication in this Action 308, the first node 111 may be enabled to share the outcome of the determination of Action 307 with another node or user, enabling to achieve the advantages already explained in relation to Action 307.

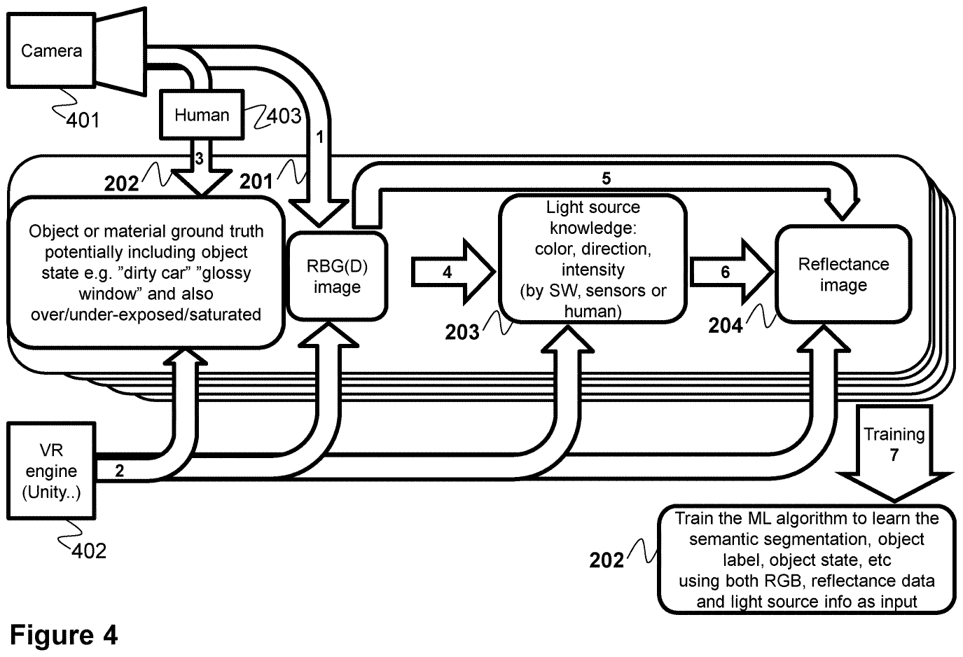

FIG. 4 is a schematic diagram depicting a non-limiting example of the method performed by the second node 112 during the training of the first predictive model 122, according to embodiments herein. As described earlier, the second node 112 may, according to Action 201, may, at 1, obtain the respective second digital image, in this example, an RBG(D) image, from a camera 401 or, at 2, from a Virtual Reality (VR) engine 402, such as e.g., Unity. In addition to what is described above for the generation of images for training, a 3D engine such as Unity may be used to create sets of images with all the input: RGB-image, semantic information, light source, and object reflective properties may be generated in the 3D engine. At 3, the second node 112 may obtain the respective annotations from a human 403, in accordance with Action 202. This may be the object or material ground truth, potentially including object state e.g., “dirty car” “glossy window” and also over/under-exposed/saturated. At 4, the second node 112 may obtain, based on the obtained respective second digital image, and in accordance with Action 203, the light source information, e.g., color, direction, intensity, by either using software (SW), sensors or a human. Next, the second node 112 may obtain the reflectance properties, e.g., a reflectance image in accordance with Action 204. This may be performed either directly based on the obtained respective second digital image at 5, or based on the obtained respective first information at 6. For the ML algorithm training a set of images may be needed. The sets of the data are shown as stacked blocks in FIG. 4. At 7, the second node 112 may, in accordance with Action 206, train the ML algorithm to learn the semantic segmentation, object label, object state, etc using both the RGB, reflectance data and the light source information as input and determine the first predictive model 122.

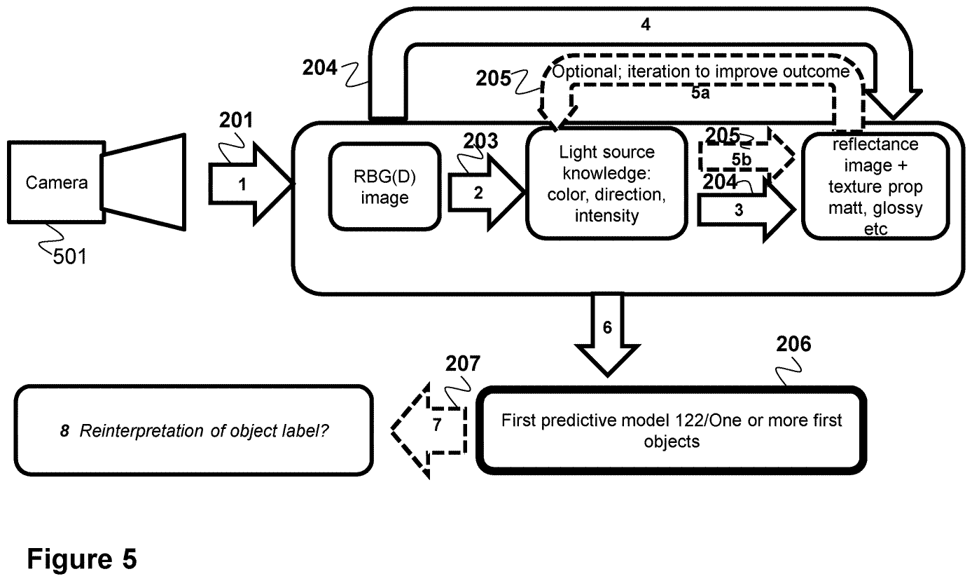

FIG. 5 is a schematic diagram depicting a non-limiting example of the method performed by either the second node 112 during the inference phase of the first predictive model 122, or by the first node 111, excluding Step 6, according to embodiments herein. To simplify the description of the Figure, the description will be provided in reference to the method performed by the second node 112 during the inference phase. As described earlier, the second node 112 may, according to Action 201, at 1, obtain a respective second digital image, in this example, an RBG(D) image, from a camera 501. At 2, the second node 112 may obtain, in accordance with Action 203, obtain, based on the obtained respective second digital image, the light source(s) properties of knowledge, e.g., color, direction, intensity using the input image according to existing methods. Next, the second node 112 may obtain a reflectance image in accordance with Action 204 at 3 using an input image and the light source or directly, based on the obtained respective second digital image at 4. Optionally, the input image, the “reflectance image” and the light source properties may be used at 5a, according to Action 205, to improve the calculation of light source properties, and further improve the “reflectance Image” at 5b, in an iterative way. At 6, the second node 112 may obtain using ML, in accordance with Action 206, the first predictive model 122, as an OD model including semantic segmentation. The second node 112 may be trained with both RGB, reflectance data and light source information. At 7, the output, in accordance with Action 207, may be object labels including higher level knowledge about state type of material, sweat, dirt, wear, etc. Wherein Action 205 may have been performed, at 8, the second node 112 may determine whether the object state/properties may support reinterpretation of object label when the score may be questionable or whether the training method may be improved. For example, a highly reflective part of a scene, may be a mirror, a puddle or a window a pile of mud may be a very dirty car or a pig. It may be understood that when performed by the first node 111, Action 302 may be performed at 1, Action 303 may be performed at 2, Action 304 may be performed at 3 and/or at 4, Action 305 may be performed at 5, Action 307 may be performed at 6, wherein the set of input images, light source input and a “reflectance image” may be used as input to the the first predictive model 122 to obtain object labels, object state/types and semantic masks. Higher-level knowledge of the state of the object may be achieved using reflective and surface property knowledge about the object, e.g., a low reflectance car, may be be a dirty car or a glossy face may be a sweaty face. This may be output according to Action 308 at 7. Finally, applying the higher-level knowledge to the already detected objects may support reinterpretation of the object. For example, a highly reflective part of a scene, may be a mirror, a water puddle or a window and a pile of mud may be a very dirty car or a pig and Action 306 may be performed at 8.

FIG. 6 is a schematic diagram depicting a further detailed non-limiting example of the method performed by the first node 111, according to embodiments herein, depicting the steps that may be performed to achieve a reflectance image. The steps depicted may be understood to correspond to Step 6 in FIG. 4 and Step 3 in FIG. 5. In this example, the respective second digital image obtained according to Action 201 depicts a house as an original image. The respective annotations obtained according to Action 202 may comprise an object label for the roof of the house, framed as a bold rectangle in the original image, and an object state as clean. The original image, the respective annotations and the illumination information obtained according to Action 203, which may include position (x, y, z), Intensity, direction (φ, θ), and/or
cone angle (α)), may be used to calculate, according to Action 204, the reflectance value as a normalized percentage “R” of the identified object “roof”, and yield a reflectance image comprising the original image, with the framed identified object “roof” and the calculated R value calculated for every pixel in the image.

FIG. 7 is a schematic diagram depicting a further detailed non-limiting example of the method performed by the second node 112. Particularly, FIG. 7 depicts a CNN framework for object label prediction, together with its state and segmentation mask. As described earlier, the second node 112 may obtain, in accordance with Action 201, for each of the sets of information, depicted in FIG. 7 as a stacked block, a respective second digital image. The second node 112 may further obtain, in accordance with Action 202, for each of the sets of information, the respective annotations. The respective annotations of the respective second digital image may indicate the respective identification of the one or more respective second objects in the respective second digital image, here, cars. The respective annotations may be understood as the object or material ground truth, potentially including object state e.g., e.g., dry, wet, dirty, rusty etc. These respective sets of information comprising the respective second images, together with the respective annotations, the categorized light source information obtained according to Action 203 and the respective reflectance images obtained according to Action 204 may be used as input to the artificial neural network 121, in this example a CNN, to, according to Action 206, train the first predictive model 122 to learn the semantic segmentation, object label, object state, etc, so that it may then also identify and provide this information as output of any objects identified in digital images used as input, in accordance with Action 207.

FIG. 8 is a schematic diagram depicting a further detailed non-limiting example of the method performed by any of the first node 111 or the second node 112 during the inference phase, according to embodiments herein. FIG. 8 illustrates how optionally, the input image, the “reflectance image” and the light source properties may be used to improve the calculation of light source properties, 4a in FIG. 8, and further improve the “reflectance Image”, 4b in FIG. 8, in an iterative way. FIG. 8 depicts how an initial RGB image may be obtained according to Action 302. The image depicts a road surrounded by trees and the sky. The road contains a puddle, which is a high reflective surface, reflecting light to some of the trees on the side or the road. The image may be, at 2, processed by the first node 111 in a first iteration, according to Action 303, to obtain an estimation of the sources of light. As depicted in FIG. 8, the light source may be wrongly estimated if the reflectance from the water puddle is not factored in. There is a high reflective object in the image, the water puddle, and it reflects the light as well as another object. As depicted in the image, in the first iteration, the sky is detected as a first source of light, and the puddle is erroneously identified as a second source of light. At 3, the image may be further processed by the first node 111 in the first iteration, according to Action 304, to obtain an estimation of the reflectance map. As depicted in the image, in the first iteration, the sky, in black, is not detected as reflective, whereas the puddle, in white, is identified as a highly reflective surface. Using this knowledge, and according to Action 305, at 4a, the first node 111, in a second iteration, redetermines the sources of light, and, based on the puddle having been identified as a highly reflective surface, is removed as a second light source, appearing in black. Then, the first node 111, at 4b, and according to Action 306, in the second iteration, determines, based on the redetermined first information, the second information. That is, the reflectance map. These may be minor, non-visible changes. After the light source information is added, the first node 111 may know that the water puddle is not an original source of the light, and the reflected objects should not be detected as real ones. Thus, after applying this knowledge obtained in the first iteration, the first node 111 may correct the prediction in the second iteration.

FIG. 9 is a schematic diagram depicting a further detailed non-limiting example of how the light source estimation and reflectance may be iteratively improved by illustrating how reflectance estimations of highly illuminated areas may be corrected in 2 steps. More particularly, FIG. 9 illustrates how more highly illuminated areas may get more precise reflectance estimations with a second iteration of light source calculation. In this example, based on an original RGB photo obtained according to Action 301 at 1, the incoming light may be calculated by the first node 111 in the first iteration according to Action 303, and high reflectance areas and especially those with high gloss, here windows, marked in solid white, giving specular reflections may be identified at 3 according to Action 304, in the first iteration. Such reflections are marked with thin arrows in the picture furthest to the right and are corrected at the first iteration. The second calculation of reflectance properties performed according to Action 305 may, in this example, re-estimate reflectance of the bright areas illuminated from the glossy surfaces. One such bright area is marked with a thick white arrow and is corrected in the second iteration. This may give the stones of the pavement in this area the same properties as the other stones in the pavement, thus reducing the risk for misinterpretation from the OD algorithms. In other words, it is not until it may be known that there are glass windows that may act as a mirror, with high reflectance and gloss, that a 2^{nd} iteration may be performed and it may be understood that the area marked with a thick arrow is in fact a dark grey area that is highly illuminated, and not a high reflectance area, that is white, that is moderately illuminated. Without this information, the OD algorithm may be understood to be unlikely to identify these stones as the same type of cobbled stones as the neighboring ones.

FIG. 10 is a schematic diagram depicting a non-limiting example of the second indication that may be output according to Action 308 by the first node 111, depicted on the right side of the Figure. Based on the first digital image obtained according to Action 302 on the left side of the Figure, and according to Action 308, the second indication output is the first digital image, with the first identified objects, cars on a road, individually marked by white rectangles, and individually marked by their respective state, in this example: clear car, rusty car, dirty car.

Certain Embodiments Herein May Provide One or More of the Following Technical advantage(s).

Embodiments herein comprise providing a novel set of inputs to an ML model, which may offer significantly richer information compared to state-of-the-art models.

According to embodiments herein, an RGB image with information about the incident light, e.g., position, direction, wavelength, spectrum, brightness, may be used to obtain the reflectance properties of each pixel. Knowing the incoming light and having the information of the amount of light that was reflected from the original RGB image may make it possible to estimate the percentage of light that may have been reflected, as illustrated in FIG. 6.

The ML algorithm may then use the incident light information and the reflectance map.

Applying the higher-level knowledge to the already detected objects may support reinterpretation of the object.

By utilizing this enhanced input data, the ML algorithm may be enabled to achieve more precise object detection, improved semantic segmentation, and provide better understanding of the state of the objects.

Higher level knowledge of the state of the object may be achieved using reflective property and texture property knowledge about the object. For example, a low reflectance car, may be a dirty car or a glossy face may be a sweaty face.

According to embodiments herein, the predicted labels and semantic may be affected much less by light source variation than existing approaches.

Advantageously, introducing knowledge of object reflectance properties in an image-based object detection system may allow for a more exact way of identifying complete and segmented parts of objects from a digital image, e.g., an RGB image, without adding requirements of additional hardware.

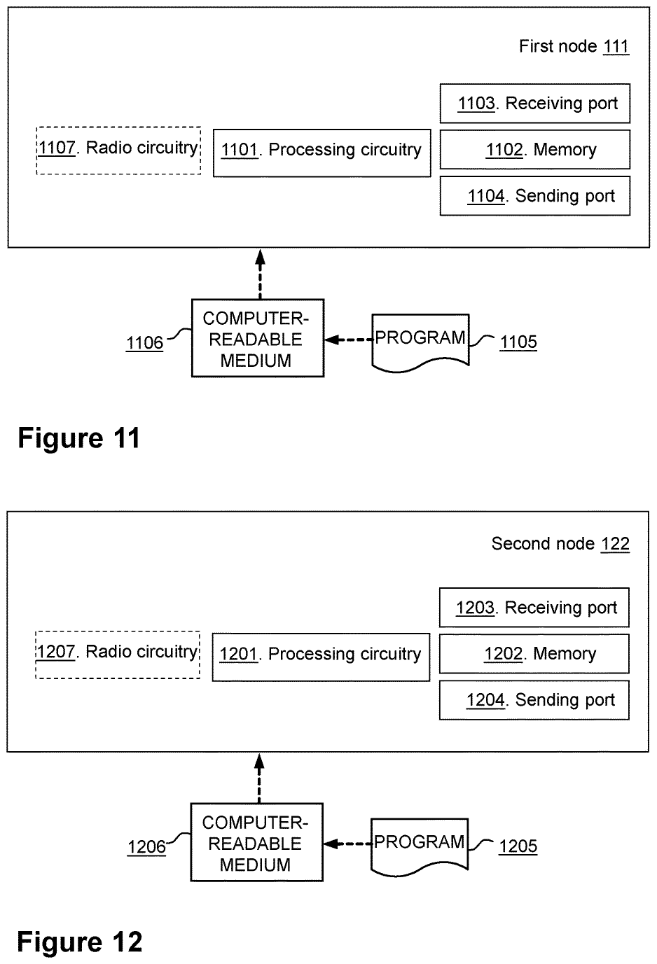

FIG. 11 depicts an example of the arrangement that the first node 111 may comprise to perform the method described in FIG. 3 and/or FIGS. 5-6 and/or FIGS. 8-10. The first node 111 may be understood to be for handling object identification. The first node 111 is configured to operate in the computer system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112, and will thus not be repeated here. For example, a digital image may be, e.g., an RGB image.

The first node 111 is configured to determine, using the first predictive model 122 to identify one or more objects in digital images, the one or more first objects in the first digital image. The determining may be configured to be based on: i) the first information configured to indicate the one or more first properties of the illumination in the first digital image, and ii) the second information configured to indicate the one or more second properties of the respective reflectance of the first digital image.

The first node 111 is also configured to initiate outputting the indication of the one or more first objects configured to be determined.

In some embodiments, the indication may be configured to indicate: a) the respective identification of the one or more first objects, and b) the third information configured to indicate the respective state of the one or more first objects configured to be identified.

In some embodiments, the first node 111 may be further configured to a) obtain the first indication of the first predictive model 122, and the output indication may be configured to be the second indication, b) obtain the first digital image, c) obtain the first information, and d) obtain the second information.

In some embodiments, at least one of the following may apply: a) obtaining the first information may be configured to comprise determining the one or more light sources of the illumination in the first digital image, b) obtaining the second information may be configured to comprise determining the reflectance map of the first digital image, c) the first information may be configured to be determined by the first node 111 based on the first digital image configured to be obtained, d) the second information may be configured to be determined, by the first node 111, based on the first information configured to be obtained, e) the second information may be configured to be determined by the first node 111, based on the first information configured to be determined by the first node 111, and f) the first indication may be configured to be obtained from the second node 112 configured to operate in the computer system 100.

In some embodiments, the first node 111 may be further configured to use the second information configured to be obtained, to redetermine the first information configured to be obtained, and the determining of the one or more first objects may be configured to be based on the first information configured to be redetermined.

In some embodiments, the first node 111 may be further configured to determine, based on the first information configured to be redetermined, whether or not one or more candidate objects configured to be initially identified in the first digital image may be one of: false positives and false negatives, and the one or more first objects configured to be determined may exclude determined false positives or determined false negatives.

The embodiments herein in the first node 111 may be implemented through one or more processors, such as a processing circuitry 1101 in the first node 111 depicted in FIG. 11, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1102 comprising one or more memory units. The memory 1102 is arranged to be used to store obtained information, store data, configurations, schedulings, and applications etc. to perform the methods herein when being executed in the first node 111.

In some embodiments, the first node 111 may receive information from, e.g., the second node 112, the radio network node 130, the device 140, and/or another structure in the computer system 100, through a receiving port 1103. In some embodiments, the receiving port 1103 may be, for example, connected to one or more antennas in first node 111. In other embodiments, the first node 111 may receive information from another structure in the computer system 100 through the receiving port 1103. Since the receiving port 1103 may be in communication with the processing circuitry 1101, the receiving port 1103 may then send the received information to the processing circuitry 1101. The receiving port 1103 may also be configured to receive other information.

The processing circuitry 1101 in the first node 111 may be further configured to transmit or send information to e.g., the second node 112, the radio network node 130, the device 140, and/or another structure in the computer system 100, through a sending port 1104, which may be in communication with the processing circuitry 1101, and the memory 1102.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 1101, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 1101.

Thus, the methods according to the embodiments described herein for the first node 111 may be respectively implemented by means of a computer program 1105 product, comprising instructions, i.e., software code portions, which, when executed on at least one processing circuitry 1101, cause the at least one processing circuitry 1101 to carry out the actions described herein, as performed by the first node 111. The computer program 1105 product may be stored on a computer-readable storage medium 1106. The computer-readable storage medium 1106, having stored thereon the computer program 1105, may comprise instructions which, when executed on at least one processing circuitry 1101, cause the at least one processing circuitry 1101 to carry out the actions described herein, as performed by the first node 111. In some embodiments, the computer-readable storage medium 1106 may be a non-transitory computer-readable storage medium, such as a CD ROM disc, or a memory stick. In other embodiments, the computer program 1105 product may be stored on a carrier containing the computer program 1105 just described, wherein the carrier is one of an electronic signal, optical signal, radio signal, or the computer-readable storage medium 1106, as described above.

The first node 111 may comprise a communication interface configured to facilitate, or an interface unit to facilitate, communications between the first node 111 and other nodes or devices, e.g., the second node 112, the radio network node 130, the device 140, and/or another structure in the computer system 100. The interface may, for example, include a transceiver configured to transmit and receive radio signals over an air interface in accordance with a suitable standard.

In other embodiments, the first node 111 may comprise a radio circuitry 1107, which may comprise e.g., the receiving port 1103 and the sending port 1104.

The radio circuitry 1107 may be configured to set up and maintain at least a wireless connection with the second node 112, the radio network node 130, the device 140, and/or another structure in the computer system 100. Circuitry may be understood herein as a hardware component.

Hence, embodiments herein also relate to the first node 111 operative to operate in the computer system 100. The first node 111 may comprise the processing circuitry 1101 and the memory 1102, said memory 1102 containing instructions executable by said processing circuitry 1101, whereby the first node 111 is further operative to perform the actions described herein in relation to the first node 111, e.g., in FIG. 3 and/or FIGS. 5-6 and/or FIGS. 8-10. FIG. 12 depicts an example of the arrangement that the second node 112 may comprise to perform the method described in FIG. 2 and/or FIGS. 5-10. The second node 112 may be understood to be for handling object identification. The second node 112 is configured to operate in the computer system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112, and will thus not be repeated here. For example, a digital image may be, e.g., an RGB image.

The second node 112 is configured to determine, using machine learning, the first predictive model 122 to identify one or more objects in digital images. The determining of the first predictive model 122 is configured to comprise training the first predictive model 122 using the plurality of sets of information. Each of the sets of information is configured to comprise: i) the respective second digital image, ii) the respective annotations of the respective second digital image configured to indicate: a) the respective identification of one or more respective second objects in the respective second digital image, and b)the respective third information configured to indicate the respective state of the one or more respective second objects configured to be identified, iii) the respective first information configured to indicate the one or more respective first properties of the illumination in the respective second digital image, and iv) the respective second information configured to indicate the one or more respective second properties of the respective reflectance of the respective second digital image.

The second node 112 is further configured to output the first indication of the first predictive model 122 configured to be determined.

In some embodiments, the first predictive model 122 may be configured to be trained to indicate: a) the respective identification of the one or more first objects in the first digital image to be input into the first predictive model 122, and b) the third information configured to indicate the respective state of the one or more first objects configured to be identified.

In some embodiments, the second node 112 may further configured to, for each of the sets of information: a) obtain the respective second digital image, b) obtain the respective annotations, c) obtain the respective first information, and d) obtain the respective second information.

In some embodiments, at least one of the following may apply: a) obtaining the respective first information may be configured to comprise determining the one or more respective light sources of the illumination in the respective second digital image, b) obtaining the respective second information may be configured to comprise determining the respective reflectance map of the respective second digital image, c) the respective first information may be configured to be determined by the second node 112 based on the respective second digital image configured to be obtained, d) the respective second information may be configured to be determined, by the second node 112, based on the respective first information configured to be obtained, e) the respective second information may be configured to be determined by the second node 112, based on the respective first information configured to be determined by the second node 112, and f) the first indication of the first predictive model 122 configured to be determined may be configured to be output to the first node 111 configured to operate in the computer system 100.

In some embodiments, the second node 112 may further configured to use the respective second information configured to be obtained to redetermine the respective first information configured to be obtained. The determining of the first predictive model 122 may be configured to be based on the respective first information configured to be redetermined.

In some embodiments, the determining of the first predictive mode may be further configured to comprise determining, for at least the respective second digital image in one set of the plurality, based on the respective first information configured to be redetermined, whether or not one or more candidate objects configured to be initially identified in the respective second digital image may be one of: false positives and false negatives. The first predictive model 122 configured to be determined may be configured to be trained to identify the one or more first objects in a first digital image to be input into the first predictive model 122 excluding false positives or false negatives.

In some embodiments, the determining of the first predictive model 122 may be configured to comprise performing the method 201, 202, 203, 204, 206 the second node 112 may be configured to perform, iteratively during the training phase, during which the first predictive model 122 may be configured to be trained with the first plurality of sets of information during the first set of iterations, and the inference phase, during which the trained first predictive model 122 may be configured to be used over the one or more second iterations to identify objects on the second plurality of sets of information. Performing the method 201, 203, 204, 206 iteratively during the inference phase may be configured to exclude the obtaining 202 of the respective annotations, and may be configured to further comprise performing the redetermining.

The embodiments herein in the second node 112 may be implemented through one or more processors, such as a processing circuitry 1201 in the second node 112 depicted in FIG. 12, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1202 comprising one or more memory units. The memory 1202 is arranged to be used to store obtained information, store data, configurations, schedulings, and applications etc. to perform the methods herein when being executed in the second node 112.

In some embodiments, the second node 112 may receive information from, e.g., the first node 111, the radio network node 130, the device 140, and/or another structure in the computer system 100, through a receiving port 1203. In some embodiments, the receiving port 1203 may be, for example, connected to one or more antennas in second node 112. In other embodiments, the second node 112 may receive information from another structure in the wireless communications network 100 through the receiving port 1203. Since the receiving port 1203 may be in communication with the processing circuitry 1201, the receiving port 1203 may then send the received information to the processing circuitry 1201. The receiving port 1203 may also be configured to receive other information.

The processing circuitry 1201 in the second node 112 may be further configured to transmit or send information to e.g., the first node 111, the radio network node 130, the device 140, and/or another structure in the computer system 100, through a sending port 1204, which may be in communication with the processing circuitry 1201, and the memory 1202.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 1201, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 1201.

Thus, the methods according to the embodiments described herein for the second node 112 may be respectively implemented by means of a computer program 1205 product, comprising instructions, i.e., software code portions, which, when executed on at least one processing circuitry 1201, cause the at least one processing circuitry 1201 to carry out the actions described herein, as performed by the second node 112. The computer program 1205 product may be stored on a computer-readable storage medium 1206. The computer-readable storage medium 1206, having stored thereon the computer program 1205, may comprise instructions which, when executed on at least one processing circuitry 1201, cause the at least one processing circuitry 1201 to carry out the actions described herein, as performed by the second node 112. In some embodiments, the computer-readable storage medium 1206 may be a non-transitory computer-readable storage medium, such as a CD ROM disc, or a memory stick. In other embodiments, the computer program 1205 product may be stored on a carrier containing the computer program 1205 just described, wherein the carrier is one of an electronic signal, optical signal, radio signal, or the computer-readable storage medium 1206, as described above.

The second node 112 may comprise a communication interface configured to facilitate, or an interface unit to facilitate, communications between the second node 112 and other nodes or devices, e.g., the first node 111, the radio network node 130, the device 140, and/or another structure in the computer system 100. The interface may, for example, include a transceiver configured to transmit and receive radio signals over an air interface in accordance with a suitable standard.

In other embodiments, the second node 112 may comprise a radio circuitry 1207, which may comprise e.g., the receiving port 1203 and the sending port 1204.

The radio circuitry 1207 may be configured to set up and maintain at least a wireless connection with the first node 111, the radio network node 130, the device 140, and/or another structure in the computer system 100. Circuitry may be understood herein as a hardware component.

Hence, embodiments herein also relate to the second node 112 operative to operate in the wireless communications network 100. The second node 112 may comprise the processing circuitry 1201 and the memory 1202, said memory 1202 containing instructions executable by said processing circuitry 1201, whereby the second node 112 is further operative to perform the actions described herein in relation to the second node 112, e.g., in FIG. 2 and/or FIGS. 5-10.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise.

The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. “Polarization-driven Semantic Segmentation via Efficient Attention-bridged Fusion”, https: //arxiv. org/pdf/2011.13313v1.pdf
2. US2021142216A1, “Method of training a machine learning system for an object recognition”, Espacenet—search results
3. “Reflective Features Detection and Hierarchical Reflections Separation in Image Sequences”, IEEE, DOI: 10.1109/DICTA.2014.7008127
4. “Minimizing the Effect of Specular Reflection on Object Detection and Pose Estimation of Bin Picking Systems Using Deep Learning” https://doi.org/10.3390/machines11010091
5. Rematas, K., Ritschel, T., Fritz, M., Gavves, E., & Tuytelaars, T. (2016). Deep reflectance maps. In Proceedings of the IEEE Conference on Computer Vision and Pattern Recognition (pp. 4508-4516).

1.-30. (canceled)

31. A computer-implemented method performed by a first node, the method being for handling object identification, the first node operating in a computer system, the method comprising:
determining, using a first predictive model to identify one or more objects in digital images, one or more first objects in a first digital image, wherein the determining is based on:
i. first information indicating one or more first properties of an illumination in the first digital image, and
ii. second information indicating one or more second properties of a respective reflectance of the first digital image, and
outputting an indication of the determined one or more first objects.

32. The method according to claim 31, wherein the indication indicates:
a respective identification of the one or more first objects, and
third information indicating a respective state of the identified one or more first objects.

33. The method according to claim 31, further comprising:
obtaining a first indication of the first predictive model, and wherein the output indication is a second indication,
obtaining the first digital image,
obtaining the first information, and
obtaining the second information.

34. The method according to claim 33, wherein at least one of:
obtaining the first information comprises determining one or more light sources of the illumination in the first digital image,
obtaining the second information comprises determining a reflectance map of the first digital image,
the first information is determined by the first node based on the obtained first digital image,
the second information is determined, by the first node, based on the obtained first information,
the second information is determined by the first node, based on the first information determined by the first node, and
the first indication is obtained from a second node operating in the computer system.

35. The method according to claim 33, wherein the method further comprises:
using the obtained second information to redetermine the obtained first information, and wherein the determining of the one or more first objects is based on the redetermined first information.

36. The method according to claim 35, wherein the method further comprises:
determining, based on the redetermined first information, whether or not one or more candidate objects initially identified in the first digital image are one of: false positives and false negatives, and wherein the determined one or more first objects exclude determined false positives or determined false negatives.

37. A computer-implemented method performed by a second node, the method being for handling object identification, the second node operating in a computer system, the method comprising:
determining, using machine learning, a first predictive model to identify one or more objects in digital images, wherein the determining of the first predictive model comprises training the first predictive model using a plurality of sets of information, wherein each of the sets of information comprises:
i. a respective second digital image, ii. respective annotations of the respective second digital image indicating:
a) a respective identification of one or more respective second objects in the respective second digital image, and
b) respective third information indicating a respective state of the identified one or more respective second objects,
iii. respective first information indicating one or more respective first properties of an illumination in the respective second digital image, and
iv. respective second information indicating one or more respective second properties of a respective reflectance of the respective second digital image, and
outputting a first indication of the determined first predictive model.

38. The method according to claim 37, wherein the first predictive model is trained to indicate:
a respective identification of one or more first objects in a first digital image to be input into the first predictive model, and
third information indicating a respective state of the identified one or more first objects.

39. The method according to claim 37, further comprising, for each of the sets of information:
obtaining the respective second digital image,
obtaining the respective annotations,
obtaining the respective first information, and
obtaining the respective second information.

40. The method according to claim 39, wherein at least one of:
obtaining the respective first information comprises determining one or more respective light sources of the illumination in the respective second digital image,
obtaining the respective second information comprises determining a respective reflectance map of the respective second digital image,
the respective first information is determined by the second node based on the obtained respective second digital image,
the respective second information is determined, by the second node, based on the obtained respective first information,
the respective second information is determined by the second node, based on the respective first information determined by the second node, and
the first indication of the determined first predictive model is output to a first node operating in the computer system.

41. The method according to claim 39, wherein the method further comprises:
using the obtained respective second information to redetermine the obtained respective first information, and wherein the determining of the first predictive model is based on the redetermined respective first information.

42. The method according to claim 41, wherein the determining of the first predictive mode further comprises determining, for at least the respective second digital image in one set of the plurality, based on the redetermined respective first information, whether or not one or more candidate objects initially identified in the respective second digital image are one of: false positives and false negatives, and wherein the determined first predictive model is trained to identify one or more first objects in a first digital image to be input into the first predictive model excluding false positives or false negatives.

43. The method according to claim 38, wherein the determining of the first predictive model comprises performing the method iteratively during a training phase, during which the first predictive model is trained with a first plurality of sets of information during a first set of iterations, and an inference phase, during which the trained first predictive model is used over one or more second iterations to identify objects on a second plurality of sets of information, and wherein performing the method iteratively during the inference phase excludes the obtaining of the respective annotations, and further comprises performing the redetermining.

44. A first node, for handling object identification, the first node being configured to operate in a computer system, the first node comprising processing circuitry configured to:
determine, using a first predictive model to identify one or more objects in digital images, one or more first objects in a first digital image, wherein the processing circuitry is configured to determine the one or more first objects based on:
i. first information indicating one or more first properties of an illumination in the first digital image, and
ii. second information indicating one or more second properties of a respective reflectance of the first digital image, and
output an indication of the one or more first objects.

45. The first node according to claim wherein the indication indicates:
a respective identification of the one or more first objects, and
third information indicating a respective state of the one or more first objects.

46. The first node according to claim the processing circuitry being further configured to:
obtain a first indication of the first predictive model, and wherein the output indication is a second indication,
obtain the first digital image,
obtain the first information, and
obtain the second information.

47. The first node according to claim 46, wherein the processing circuitry is configured to at least one of:
obtain the first information by determining one or more light sources of the illumination in the first digital image,
obtain the second information by determining a reflectance map of the first digital image,
determine the first information based on the first digital image,
determine the second information based on the first information,
determine the second information based on the first information, and
obtain the first indication from a second node configured to operate in the computer system.

48. The first node according to claim 46, wherein the processing circuitry is further configured to use the second information to redetermine the first information, and determine the one or more first objects based on the redetermined first information.

49. The first node according to claim 48, wherein the processing circuitry is further configured to:
determine, based on the redetermined first information, whether or not one or more candidate objects initially identified in the first digital image are one of: false positives and false negatives, and wherein the one or more first objects exclude determined false positives or determined false negatives.

50. A second node, for handling object identification, the second node being configured to operate in a computer system, the second node comprising processing circuitry configured to:
determine, using machine learning, a first predictive model to identify one or more objects in digital images, wherein the processing circuitry is configured to determine the first predictive model by training the first predictive model using a plurality of sets of information, wherein each of the sets of information comprises:
i. a respective second digital image,
ii. respective annotations of the respective second digital image configured to indicate:
a) a respective identification of one or more respective second objects in the respective second digital image, and
b) respective third information indicating a respective state of the one or more respective second objects,
iii. respective first information indicating one or more respective first properties of an illumination in the respective second digital image, and
iv. respective second information indicating one or more respective second properties of a respective reflectance of the respective second digital image, and
output a first indication of the first predictive model.
